(19) United States
(12) Patent Application Publication
(10) Pub. No.: US 2025/0077762 A1
(43) Pub. Date: Mar. 6, 2025

(54) System and Method for Text Editing Using Large Language Models

(71) Applicant: Jasper AI, Inc., Annapolis, MD (US)

(72) Inventors: Adam SCHAUER, Los Altos Hills, CA (US); Huxley MARVIT, San Francisco, CA (US); Selina MARVIT, San Francisco, CA (US); Dylan WALLACE, San Mateo, CA (US); Albert HUANG, Redwood City, CA (US); Houjun LIU, Menlo Park, CA (US); Lachlan MARVIT, Oakland, CA (US); Yehong JIANG, Los Altos, CA (US); Riley DENOYER, San Jose, CA (US); Oscar CAPRARO, San Francisco, CA (US); Micah ROBINSON, Menlo Park, CA (US); Parley MARVIT, Oakland, CA (US)

(21) Appl. No.: 18/823,555

(22) Filed: Sep. 3, 2024

Related U.S. Application Data
(60) Provisional application No. 63/536,422, filed on Sep. 3, 2023.
(60) Provisional application No. 63/538,818, filed on Sep. 16, 2023.

(51) Int. Cl. G06F 40/109

(52) U.S. Cl. CPC G06F 40/109

(57) ABSTRACT

An effect stack for an abstracted text modification system and methods thereof. Instead of modifying text in-place, the effect stack maintains effects in a saved stack separately from the source text, allowing text to flow without modifying the ground truth until desired. This effect stack allows for effects to be applied and updated/edited after the fact for a powerful interface.

### CROSS-REFERENCE TO RELATED APPLICATIONS

This application claims priority to U.S. Provisional Application Ser. Nos. 63/536,422, which was filed Sep. 3, 2023, and 63/538,818, which was filed Sep. 16, 2023, the disclosures of which are hereby incorporated by reference in their entirety and for all purposes.

### FIELD

The disclosed embodiments relate generally to artificial intelligence (AI) and more particularly, but not exclusively, to a method and system for document readers and abstracted text editing using an AI model.

### BACKGROUND

Developments in artificial Intelligence (AI) have created many opportunities to manipulate text in entirely new ways. Computational systems can manipulate characters at multiple levels (e.g., words, punctuations, sentences, paragraphs) for years. Copying and pasting text is such a manipulation. Spell check is another. But, for the most part, conventional solutions cannot manipulate style or semantics.

The old mental model was that text could be moved (i.e., copied and pasted). Spell check and grammar check was based on simple pattern matching. ChatGPT, developed by OpenAI, updated the mental model. ChatGPT is a chatbot and virtual assistant based on large language models (LLMs) that enables users to refine and steer a conversation towards a desired length, format, style, level of details, and language.

Text editing with ChatGPT has been analogized to outsourcing-writers could pass text to ChatGPT with a set of requests to, for example, manipulate the style. ChatGPT could then function as a consultant or digital assistant and rewrite the text to the user's specifications. For example, writers could ask for their text to be rewritten in the style of Hemmingway or, alternatively, at the level of a fifth-grade student.

But the new mental models enabled by ChatGPT miss several emergent possibilities. By thinking of text in new ways, new possibilities for representation, visualization, and modification become possible.

Furthermore, people are inundated with ever more documents to assimilate. Students and businesspeople are especially prone to having to understand documents that were not written with them in mind. Often authors assume considerable domain knowledge thereby confounding the uninitiated.

Documents are frequently written at a reading level above, or below, the reader. Writers are forced to make assumptions about their readers and hope for the best-trying to balance not confusing some readers while not boring others. Inevitably this leaves many readers underserved.

Beyond reading level and domain knowledge, authors are forced to make decisions about style, density, and tone, among other things. These choices may suit some readers and hinder others.

Text documents can come in a variety of formats (including .txt, .pdf, .doc, .docx, .epub, .mobi, .rtf, .tex, .html, and more.). Conventional tools (e.g., hardware devices as well as software programs such as .pdf readers, applications, web browsers) allow users to consume text documents. Software that supports reading these documents can run on a variety of devices such as mobile phones, tablets, laptop and desktop computers, wearables, and so on. Many of these applications offer other features as well, including support for managing document collections, editing documents, and converting between document formats. As used throughout, any device or software that enables reading of documents is referred to as a document reader-even if it also offers other capabilities and even if those other capabilities are “primary.” The documents these applications consume are also referenced as text documents even if they contain images, formatting information (such as markup or markdown), video, interactive elements, metadata, and/or other content types that are not purely textual.

Many of these applications and devices allow users to set various parameters for how these documents are presented. These typically include font and font size, text color, background color (or texture), and so on. These settings are designed to give the user a customized and optimal reading experience. These systems are based around the recognition that every user is different and may have different preferences. However, these preferences are currently quite limited, and can be substantially extended.

In view of the foregoing, there is a need for an improved system and method for text editing using large language models that overcome the drawbacks of existing solutions.

### BRIEF DESCRIPTION OF THE DRAWINGS

FIG. 1 is a diagram illustrating one exemplary embodiment of a graph generalization of an effect stack.

FIG. 2 is a diagram illustrating one exemplary embodiment of a cross-dimensional node of the non-linear effect graph of FIG. 1.

FIG. 3 is a diagram illustrating an exemplary embodiment a splitter node of the non-linear effect graph of FIG. 1.

FIG. 4 is a diagram illustrating an exemplary embodiment a combiner node of the non-linear effect graph of FIG. 1.

FIG. 5 is a diagram illustrating another exemplary embodiment a combiner node of the non-linear effect graph of FIG. 1, showing stream types and weights of the edges between nodes.

FIG. 6 is a diagram illustrating another exemplary embodiment a splitter node of the non-linear effect graph of FIG. 1, showing a node with multiple outputs.

FIG. 7 is a diagram illustrating one exemplary embodiment of a linear effect stack of FIG. 1.

FIG. 8 is a diagram illustrating one exemplary embodiment of the data flow for applying an effect using the linear effect stack of FIG. 7.

FIG. 9 is a diagram illustrating one exemplary embodiment of commutativity, caching, and parallel processing the linear effect stack of FIG. 1.

FIG. 10 is a diagram illustrating one exemplary embodiment of a document reader that can be used with the effect stack of FIG. 1.

FIG. 11 is a diagram illustrating one exemplary embodiment of textual transparency that can be used with the effect stack of FIG. 1.

FIG. 12 is a diagram illustrating another exemplary embodiment of textual transparency that can be used with the effect stack of FIG. 1.

FIG. 13 is a diagram illustrating one exemplary embodiment of a location attribute that can be used with the textual transparency of FIGS. 11-12.

FIG. 14 is a diagram illustrating one exemplary embodiment of an incremental delete that can be used with the textual transparency of FIGS. 11-12.

FIG. 15 is a diagram illustrating one exemplary embodiment of the data flow for an altercation of an elastic summary using the effect stack of FIG. 1.

FIG. 16 is a diagram illustrating one exemplary embodiment of the data flow for the downstream effects of using the effect stack of FIG. 1.

FIG. 17 is a diagram illustrating another exemplary embodiment of the data flow for the downstream effects of using the effect stack of FIG. 1.

FIG. 18 is a diagram illustrating one exemplary embodiment of a textual vectorscope using the effect stack of FIG. 1.

FIG. 19 is a diagram illustrating another exemplary embodiment of a textual vectorscope using the effect stack of FIG. 1.

FIG. 20 is a diagram illustrating an exemplary embodiment of a software architecture for implementing the effect stack of FIG. 1.

FIG. 21 is a diagram illustrating an exemplary embodiment of a machine for implementing the effect stack of FIG. 1.

FIG. 22 is a diagram illustrating an exemplary embodiment of a concept parser.

FIG. 23 is a diagram illustrating an exemplary embodiment of a concept extractor for use with the concept parser of FIG. 22.

FIG. 24 is a diagram illustrating an exemplary embodiment of a concept selector for use with the concept parser of FIG. 22.

FIG. 25 is a diagram illustrating an exemplary embodiment of using the concept selector of FIG. 24.

FIG. 26 is a diagram illustrating another exemplary embodiment of using the concept selector of FIG. 24.

FIG. 27 is a diagram illustrating another exemplary embodiment of using the concept selector of FIG. 24.

FIG. 28 is a diagram illustrating another exemplary embodiment of using the concept selector of FIG. 24.

FIG. 29 is a diagram illustrating an exemplary embodiment of a textual attribute specifier using the concept picker of. FIG. 22.

FIG. 30 is a diagram illustrating an exemplary embodiment of an eyedropper using the concept selector of FIG. 28.

FIG. 31 is a diagram illustrating an exemplary embodiment of an external concept display using the concept picker of. FIG. 22.

FIG. 32 is a diagram illustrating one exemplary embodiment of a user interface for continuous text modification using an effect stack of FIG. 1.

FIG. 33 is a diagram illustrating one exemplary embodiment of the data flow for a text update using the continuous text modification of FIG. 32.

FIG. 34 is a diagram illustrating another exemplary embodiment of a user interface for continuous text modification of FIG. 32.

FIG. 35 is a diagram illustrating another exemplary embodiment of a user interface for continuous text modification of FIG. 32.

FIG. 36 is a diagram illustrating an exemplary embodiment of text mapping between latent space and rendered text of the continuous text modification of FIG. 32.

FIG. 37 is a diagram illustrating another exemplary embodiment of text mapping between latent space and rendered text of the continuous text modification of FIG. 32.

FIG. 38 is a diagram illustrating an exemplary embodiment of a security measure of the continuous text modification of FIG. 32.

FIG. 39 is a diagram illustrating another exemplary embodiment of the security measure of FIG. 38.

FIG. 40 is a diagram illustrating another exemplary embodiment of a user interface for continuous text modification of FIG. 32.

FIG. 41 is a diagram illustrating one exemplary embodiment of textual smoothing on inserted text.

FIG. 42 is a diagram illustrating another exemplary embodiment of textual smoothing on inserted text.

FIG. 43 is a diagram illustrating one exemplary embodiment of the data flow textual smoothing on inserted text of FIG. 41.

FIG. 44 is a diagram illustrating one exemplary embodiment of regional smoothing of FIG. 41.

FIG. 45 is a diagram illustrating one exemplary embodiment of generative smoothing of FIG. 41.

FIG. 46 is a diagram illustrating another exemplary embodiment of regional smoothing of FIG. 45.

FIG. 47 is a diagram illustrating one example embodiment of updating a document profile.

FIG. 48 is a diagram illustrating one example embodiment of zooming over base text.

FIG. 49 is a diagram illustrating another example embodiment of zooming over base text.

FIG. 50 is a diagram illustrating one example embodiment of exporting base text.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

The systems and methods for abstracted text editing techniques described herein are based on a new way of thinking about text and new ways that it can be: represented, visualized, and modified.

### Representation

Text can be thought of as a rendering of underlying dimensions that are distinct from the actual characters. By defining these dimensions, describing the text along these dimensions, manipulating these dimensions, visualizing them, and rendering them back into new text, many possibilities emerge. By representing the text along many dimensions, text can be thought of as continuous along these many dimensions, as compared to existing in a discrete space of words and characters. Advantageously, content becomes distinct and separately manipulable from style.

Some examples of dimensions include, but are not limited to, concisions (i.e., concise to verbose), formality (i.e., casual to formal), understandability (i.e., simple to complex), polish (i.e., bullet points to prose), and so on. These many dimensions can be broken into smaller sub-units, i.e., sub-dimensions.

Non-rendered text is considered “latent” text, which exists in a high dimensional latent space. This latent text—while not necessarily human readable—can be operated on computationally. Being continuous, this latent space can have a much finer granularity than the discrete world of characters.

### Visualization

By showing a user the text as represented along these multiple dimensions, the user can perceive aspects of the text quickly, improving their ability to assess the text and guide their efforts to modify it. This new form of text editing requires a way for edits to understand text and how it rapidly changes. The systems and methods described herein provide a user interface to provide users significantly faster understanding of a text for the purpose of understanding candidate manipulations impact on the text. This advantageously enables faster and more granular manipulation compared to existing computational methods.

### Modifications

Once text is represented as existing along a set of dimensions (some continuous, and possibly some not) it can be manipulated in entirely new ways. The systems and methods described herein can, among other things, move the text along different dimensions.

### Effects

Drawing analogy from image, video, and audio editing techniques, the systems and methods disclosed herein provide filters, generators, viewers, and so on. For sake of brevity, these features can be broadly categorized as “effects.” Effects take inputs and produce outputs. For example, effects can take source text as input and output a modified version of the source text, output an extension of the source text, output some visualization of the source text, and so on. Effects are the individual units that form the backbone of the disclosed abstracted text editing techniques.

The disclosed abstracted text editing techniques extend the computationally modifiable attribute space of text far beyond what it was previously. Instead of “make the text italicized,” (italicized attribute) or “make the text Helvetica,” (font attribute) there exists additional attributes such as concision, formality, and understandability, such as mentioned above. Additional attributes include, but are not limited to, sentiment, attitude, density, personality, adherence (to original text), modernity, energy, opinion, persuasiveness, depth, genre, confidence, literalness, writing style, writer's voice, intended audience, emotion, tone, latent attributes that do not have names, and so on. While some of these attributes exist on a binary, or an otherwise discrete space, many exist along a continuum. These attributes are referred to as textual attributes.

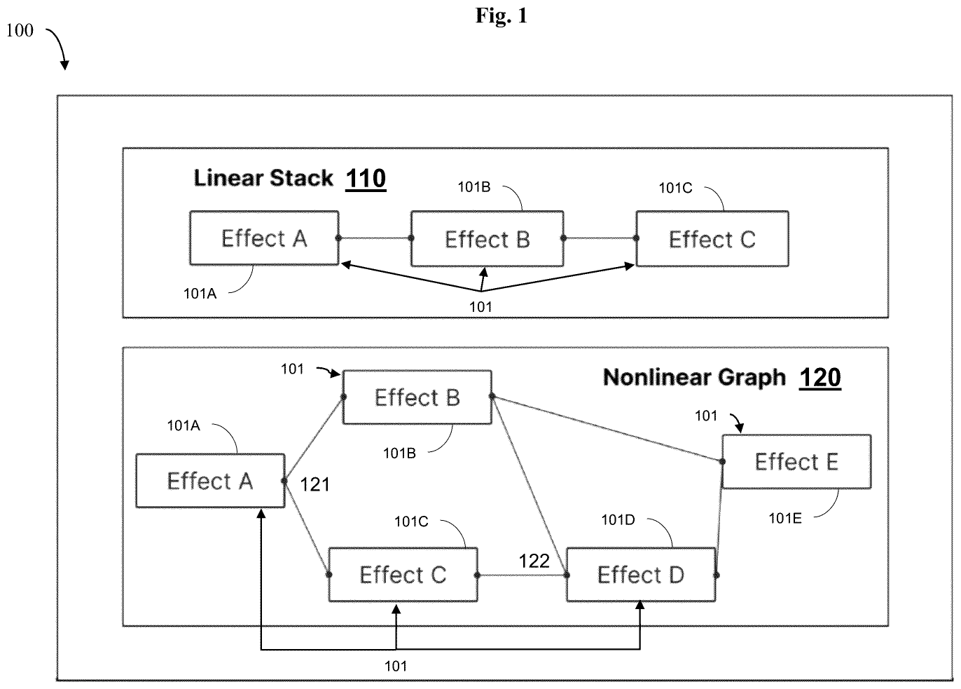

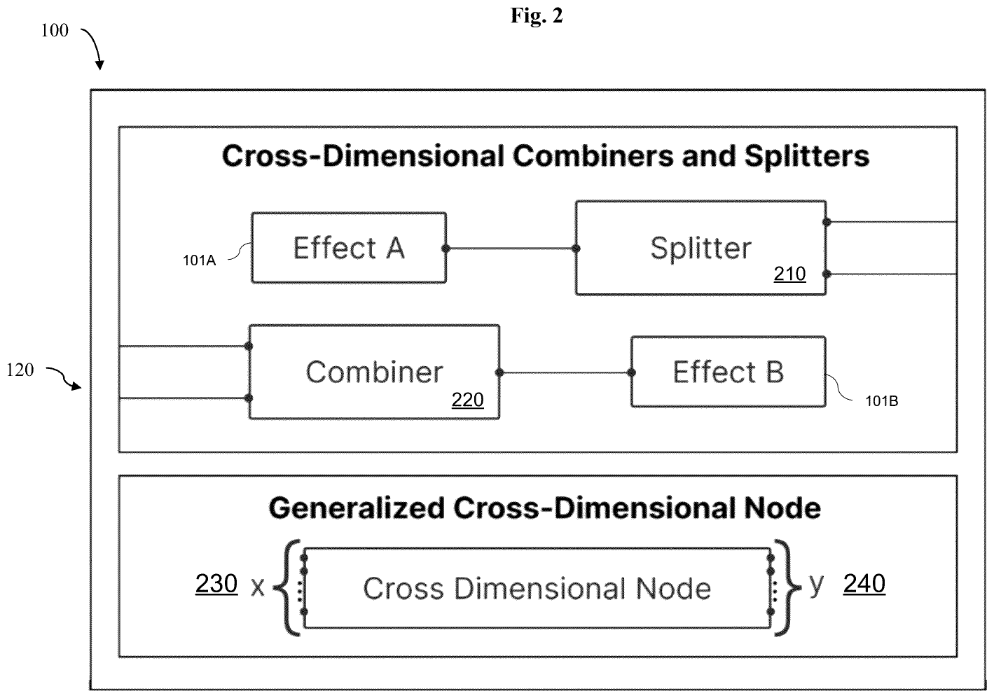

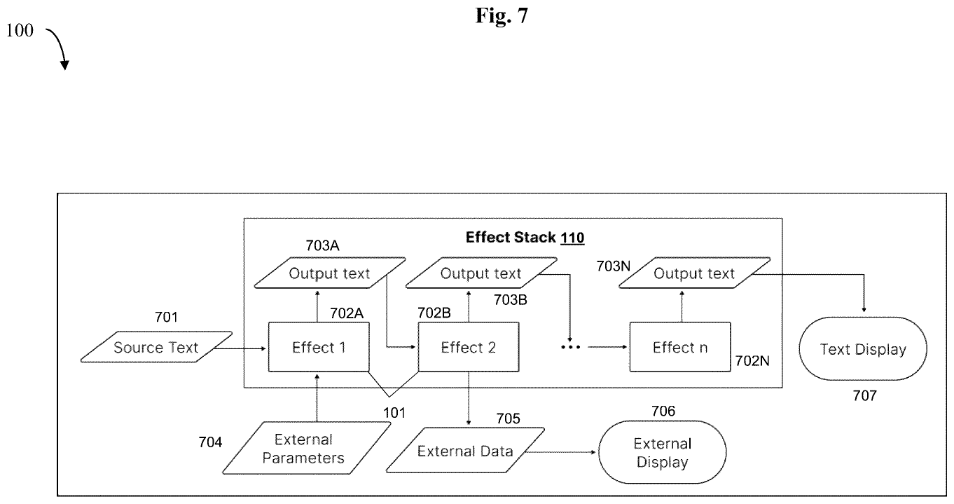

FIG. 1 shows the difference between a linear effect stack (discussed with reference to FIGS. 7-9) and a nonlinear effect graph. While the flow of text in the effect stacks travels linearly from one effect to the next, the effect graph allows for much more complex nonlinear flow. This nonlinear flow accommodates the existence of nodes with a different number of inputs and outputs, called cross-dimensional nodes (discussed with reference to FIG. 2).

Turning to FIG. 1, an exemplary computing environment 100 is shown. The computing environment 100 includes a linear effect stack 110, which includes one or more effects 101. As shown, the output of one effect 101 flows into the next. For example, in the linear stack 110, the output of effect 101A (effect A) is provided as the input to effect 101B (effect B). This linear flow is repeated for n effects (shown through effect 101C (effect C)) until the resultant text us outputted. Although not shown, there are also input and output nodes of the linear stack 110, providing an input source of text for effect 101A and an optional visualization of the output of effect 101C.

The computing environment 100 additionally includes a non-linear effect graph 120. Although the linear effect stack 110 can be represented as a form of the non-linear effect graph 120, the non-linear effect graph 120 cannot be represented as a linear effect stack 110. In other words, effect stacks are a subset of effect graphs. In the non-limiting example of the nonlinear effect graph 120, there are five nodes with complex connectivity, including multiple branches, inter-branch connections, multiple inputs, and multiple outputs.

For example, node 121 refers to the one or more outputs of the effect 101A. Although shown and described as a single output, nodes with multiple outputs are discussed with reference to FIG. 2. A node 122 refers to the one or more inputs for the effect 101D. Similarly, although shown and described as a single input, nodes with multiple inputs are discussed with reference to FIG. 2.

In some embodiments, the non-linear effect graph 120 can include one or more cross-dimensional nodes as shown in FIG. 2. Cross-dimensional nodes can convert between “dimensions” of one or more effects 101. In other words, cross-dimensional nodes dynamically accommodate any number of inputs and outputs that effects can have. Nodes can have any number of inputs and outputs.

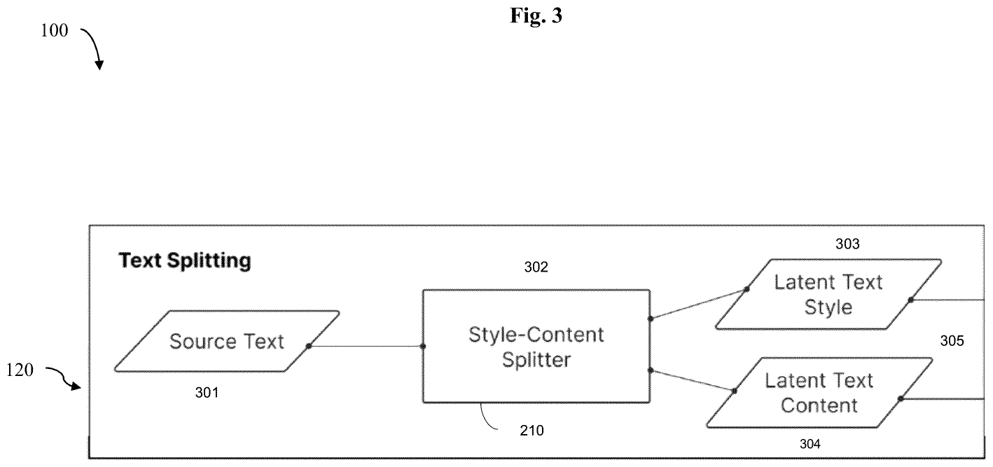

Turning to FIG. 2, the non-linear effect graph 120 includes splitters and combiners, which represent two general non-limiting types of cross-dimensional nodes. A splitter 210 takes inputs and splits them apart into multiple possible edges (also referred to herein as “streams”). For example, as shown in FIG. 2, the splitter 210 receives its input from the effect 101A, which input is split into two streams or edges. The splitters 210 can split input text in many ways, such as by conceptual splitting, textual attribute splitting (separating out any textual attributes), and text break splitting (e.g., paragraph breaks). An exemplary input being split is shown in FIG. 3.

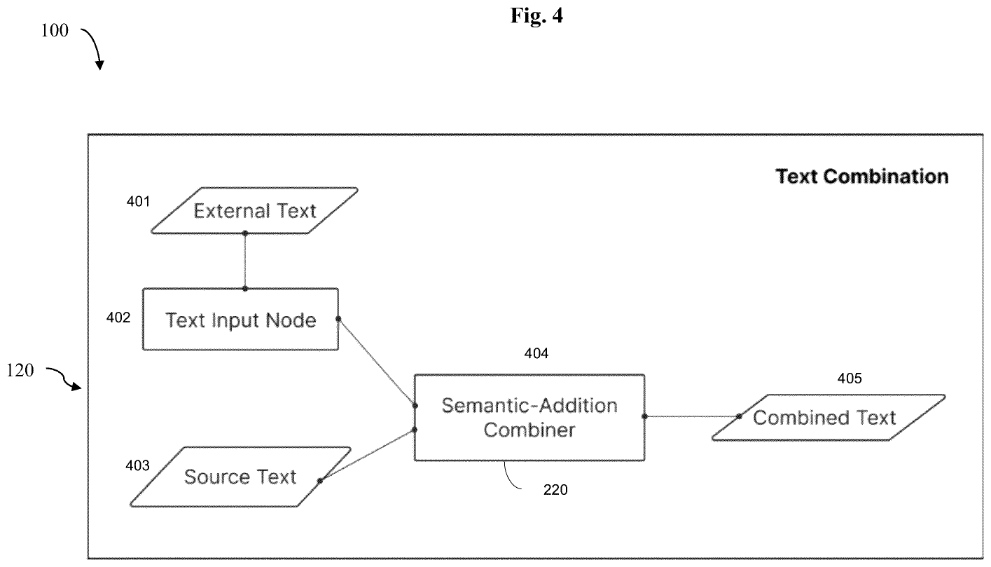

A combiner 220 is another cross-dimensional node type. The combiner 220 is the conceptual counterpart to the splitter: rather than splitting separate streams or edges according to a splitting type, the combiner combines separate streams according to the combination type. For example, as shown in FIG. 2, the combiner 220 can receive two streams as input (e.g., such as resulting from the splitter 210), which input is combined into a single stream or edge as input to the effect 101B. Exemplary combination types include semantically additive, semantically subtractive, “best” along predetermined criteria (e.g., most interesting, most understandable, most well-written, closest style match to the remaining text, and so on), and sort of “blending mode” (e.g., difference, exclusion, behind, dissolve, and so on), and/or a natural language input as instruction for carrying out the combination. These exemplary combination modes are analogous to the ability of an image editor software to blend images when overlaying, such as shown in FIG. 4.

FIG. 2 also illustrates a more generalized cross-dimensional node with any number of x inputs (shown as input 230) and any number of y outputs (shown as output 240). It should be noted that although the cross-dimensional node primarily accommodates a differing number of inputs 230 and outputs 240, the number of x inputs and y inputs can be equal.

FIG. 3 illustrates the dataflow of an exemplary splitter node 210, such as a style-content splitter 302. The style-content splitter 302 receives input text, such as from a source text 301, and splits the input text stream into a style stream 303 (shown as latent text style data) and a content stream 304 (shown as latent text content data). The style stream 303 can isolate only the style of the source text 301 (optionally, to be passed into later effects 101 that only need to process the style of the text). The style stream 303 can include no information about the original content of the source text 301, and instead only include its style.

The content stream 304 can isolate the content of the source text 301. IN toher words, while this data may not be human readable, it can represent semantically the same conceptual information as the source text 301. This separation scheme (or separation mode) for the style-content splitter 302 is just one of many possible modes. And other separation schemes can exist, including, for example, splitting into separate concepts, separating textual attributes, natural language description of splitting criteria, and so on. The style-content splitter 302 then allows its separate streams to be modified separately, and then later optionally recombined. The combined output of the style stream 303 and the content stream 304 is shown as stream 305, which can represent how the latent text can optionally be passed onto future nodes in the non-linear effect graph 120.

FIG. 4 illustrates the dataflow of an exemplary combination node 220, such as a semantic-addition combiner 404. As shown, the semantic-addition combiner 404 adds its input streams. Semantic addition nodes can have any number of input streams and is only shown as combining two input streams for illustration purposes. The semantic-addition combiner 404 combines the meaning of source text 403 and a piece of external text 401 to yield combined text 405 with the semantic meaning of both the source text and the external text. The external text 401 could be any external text that includes the semantics to be combined with the source text by the combination node 220. A text input node 402 hosts the content of the external text 401 in the context of the graph. This node 402 is occasionally omitted from the figures for the sake of simplicity, instead being represented by a direct connection between the data and the effect 101 it's being inputted into. Note that these input nodes can host a broad variety of content beyond just text.

The semantic-addition combiner 404 can combine multiple separately modified branches of the non-linear effect graph 120 back into fewer nodes, or even a single node as shown in FIG. 4. Although not shown, one or more splitting nodes 210 may exist to provide utility for the one or more combination nodes.

This combination scheme (or combination mode) for the semantic-addition combiner 404 is just one of many possible modes. And other combination modes can include, for example, semantically additive, semantically subtractive, choosing the “best” segment based on predefined criteria, a natural language description of how to carry out a combination, and the textual equivalent of any image “blending modes.” By way of example, another blending mode includes “dissolve,” which can randomly sample from its inputs to dissolve texts into each other. Another example is “difference,” which could output the differences between two or more streams. “Behind” is another combination mode that fills in text behind “transparent” text, such as providing the textual equivalent of adding a .png file with certain clear segments on top of another image, allowing the image beneath to fill in its transparent sections.

In some embodiments, some combination modes assume input streams are distinct, while other combination modes assume input streams are indistinct. In other words, there is a level of input commutativity. For example, in the example shown in FIG. 4, the semantic-addition combiner 404 assumes all inputs are indistinct. However, for a “behind” combination mode, which piece of data is connected to which input stream dictates the order of the text segments in combination. Similarly, for an “exclusion” combination mode, or any other mathematical based operation mode, the order of the text segments defines the way the inputs are processed.

Additionally and/or alternatively, some combination modes can be “fuzzy”, which is optionally based on a user parameter, creating more or less strict combination modes.

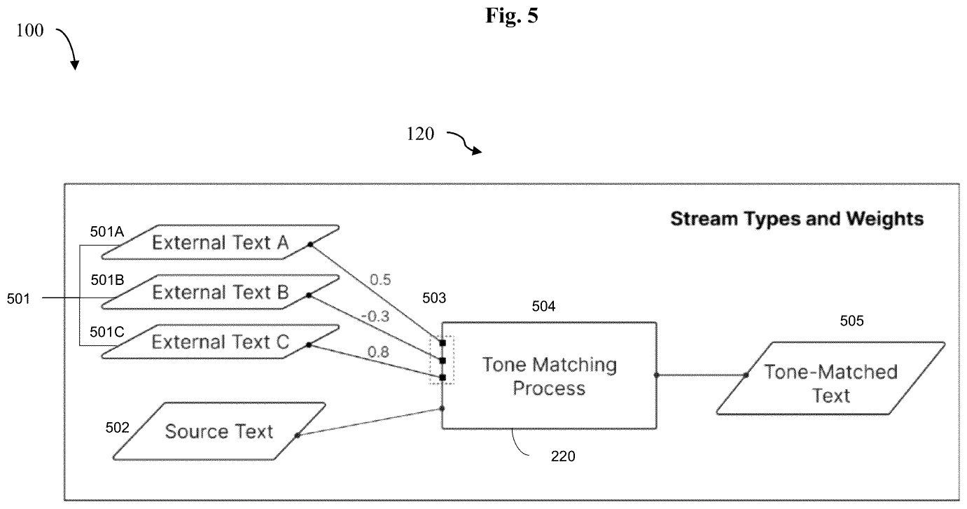

FIG. 5 illustrates an exemplary embodiment of stream types and stream weights that can be used with the non-linear effect graph 120. In some embodiments, nodes can differentiate between the type of input they expect with differing stream types. By way of example, with reference to FIG. 5, source text 502 is passed into a combination node 220, such as a tone matching process block 504, along with three pieces of external text 501, such as external text 501A-C(e.g., external text A, external text B, external text C). The tone matching process block 504 is set to a “tone matching” mode, thus producing tone-matched text 505 as output. In other words, the tone matching process block 504 takes in context streams providing a tone and a source stream (or multiple source streams) to apply the tone to.

Notably, there are two stream types at play in this example: first, the source stream from the source text 502, providing a source of text to be modified. This is graphically represented as a line flowing into a circle. Second, there are context streams. These are represented by a line flowing into a square. These context streams are distinct from source streams and, instead, provide context for the effect 101 they are being passed into to operate. As shown in FIG. 5, the context streams provide an example of the tone to match, while the source stream provides the actual text to be modified to match a tone. Many different types of streams can exist, not limited to only source and context.

Stream weights, such as stream weights 503, allow different input sources to be weighted differently, impacting the effect they are being passed into based on their weights. Stated differently, weights are a global multiplier on text transparency. In some embodiments, textual transparency is a form of metadata that weights textual attributes (including but not limited to location, content, formality, style, or any other textual attributes) to allow users significant and fine control over how text gets modified (optionally through our abstracted text editing system). When applying any attribute, users can adjust the transparency value of said attribute much like one adjusts the alpha channel in RGBA coloring. Just like certain sections of a PNG can be transparent, this textual transparency gives weights to attributes, controlling its relative influence when combined with other attributes. Attributes operate as vectors, and transparency operates as a scalar multiplier of each vector, changing the magnitude (weight) but not the direction (characteristics) of each. These weights may not apply directly to the latent text, but instead act as weights for how much to “value” maintaining certain attribute states when text needs to get modified or combined with other text. One key textual attribute that transparency allows for is location, granting the function of the presence of text without requiring actual existing text. This is a form of locational placeholder text.

By way of example, if a user wants to apply both a formal and assertive tone effect on a piece of base text, none of the assertive tone effects would be visible when applying first the assertive and then the formal effect if formality is given a 0% transparency. If formality is given 100% transparency, only the assertive tone effects would be visible. The user has full freedom to adjust the transparency of either effect. This transparency value can also be hosted inside the text itself, instead of in the effect. In some embodiments, adjusting the transparency of a single effect, without the presence of other effects, may not result in a text change. Transparency also operates on the interactions between effects that do not necessarily fall into the same “category” (as opposed to the assertive and formal effects, which are both tones). Transparency can be applied in many ways such as (but not limited to) a constant value or a gradient, and can be fixed to differing aspects of the text, such as selected sections, location with respect to a point, or global location. Transparency values can be visually represented in many ways-such as (but not limited to) visual transparency.

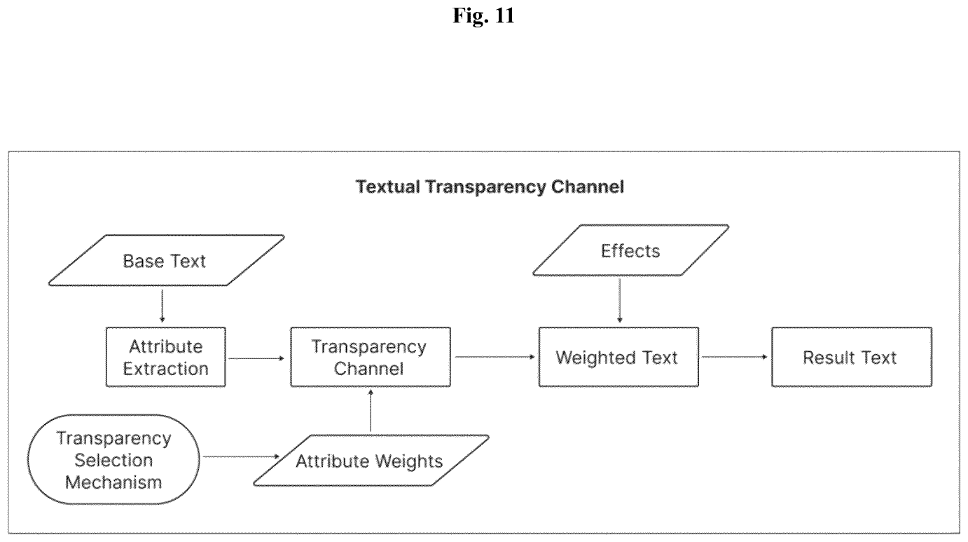

Textual transparency is further described with reference to FIGS. 11-14. As shown in FIG. 11, transparency can be altered globally or on the scale of individual attributes. Users can modify transparency directly or through proxy systems. In some embodiments, these modifications are entirely automatic. As shown in FIG. 11, existing text attributes of the base text are identified and extracted (as are their initial values) and attribute weights are fed into the transparency channel. This channel creates “weighted text,” which can exist only internally to the system. Effects (chosen by the user) are applied to the weighted text, which results in the final text output. In this figure, effects are directly applied to the weighted text. However, it should be understood that effects can be combined, layered, and applied.

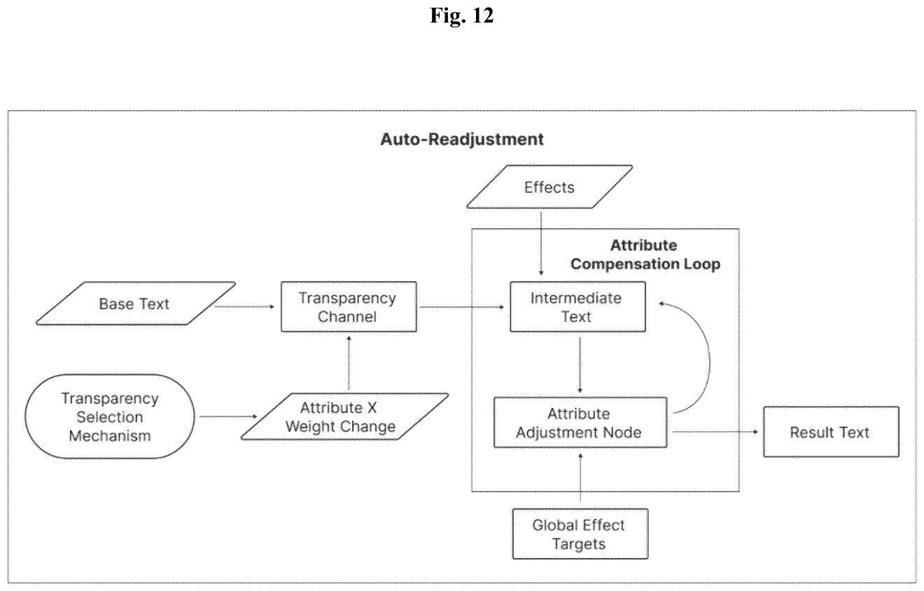

FIG. 12 illustrates an implementation of attribute auto-readjustment to correct unintended consequences of transparency adjustments and isolate user edits to a single attribute. For example, linearly dependent attributes (e.g., clarity and concision) are affected by their respective attribute transparencies. Auto-readjustment allows the user to adjust the transparency of clarity while maintaining the unaffected presence of concision. As shown in FIG. 12, a change of attribute x is fed into the transparency channel, which creates internal intermediate text. Specified effects are applied and the values of any dependent (but ideally unchanged) effects are evaluated in comparison to the, in this example, user-specified global effect targets. Any discrepancies are corrected by the attribute adjustment node, which creates new intermediate text. This process can be repeated in the attribute compensation loop until the desired global effect targets are reached, resulting in final text.

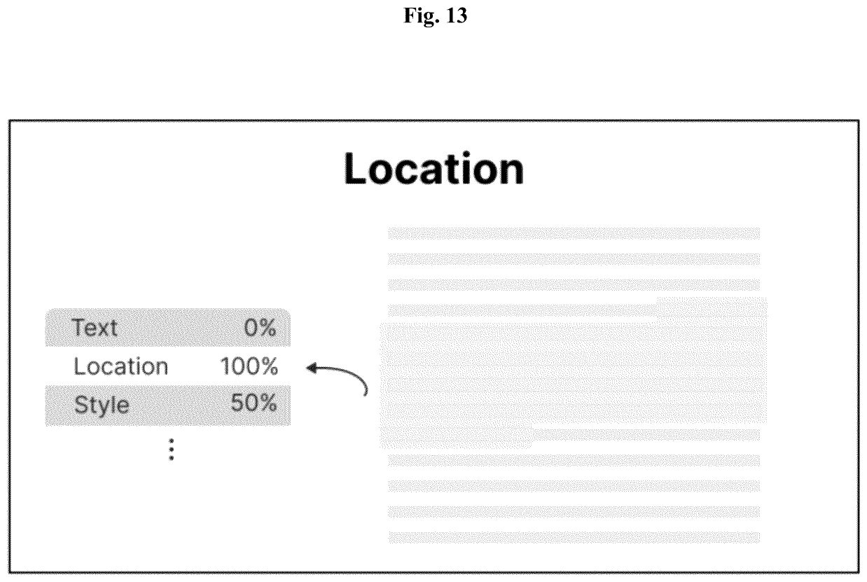

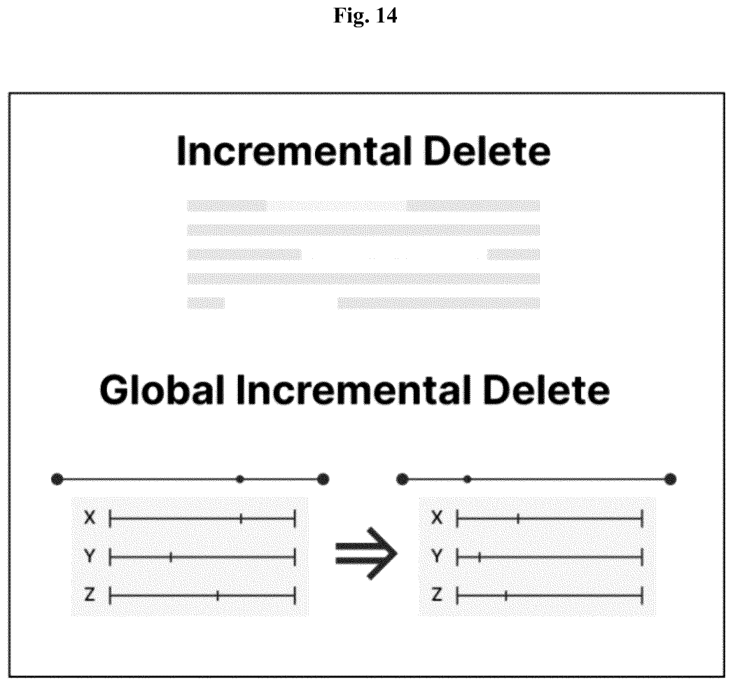

FIG. 13 shows the location attribute, which represents the “space” that text takes up. By decreasing the transparency of text, as shown in FIG. 13, and maintaining location, users can create text-less text or “placeholder space” to maintain an indeterminate amount of metadata without the presence of any readable text. This can be used to create distance between sections of text (e.g., chapters) while maintaining attribute and effect data. FIG. 14 illustrates incremental delete, which is one possible use of the transparency function. The incremental delete can be used to partially delete certain sections of text, either discretely (as shown) or in a continuous gradient. Partial deletion allows for more user direction and greater ability to manipulate text. Global incremental delete represents a change in the transparency of the text itself, thus affecting the presence of other effects.

Turning back to FIG. 5, the stream weights 503 are shown as weights on the context streams. In some embodiments, every stream can have multiple weights, modifying different textual attributes of the text. Weights can also be negative, such as shown for the context stream from the external text 501B to the tone matching process block 504. The negative weight pushes the effect away from the negative input. In other words, the external text 501B includes a tone that is steered away from when generating tone-matched text 505, which is the source text 502 with weighted tones from the context streams applied to it.

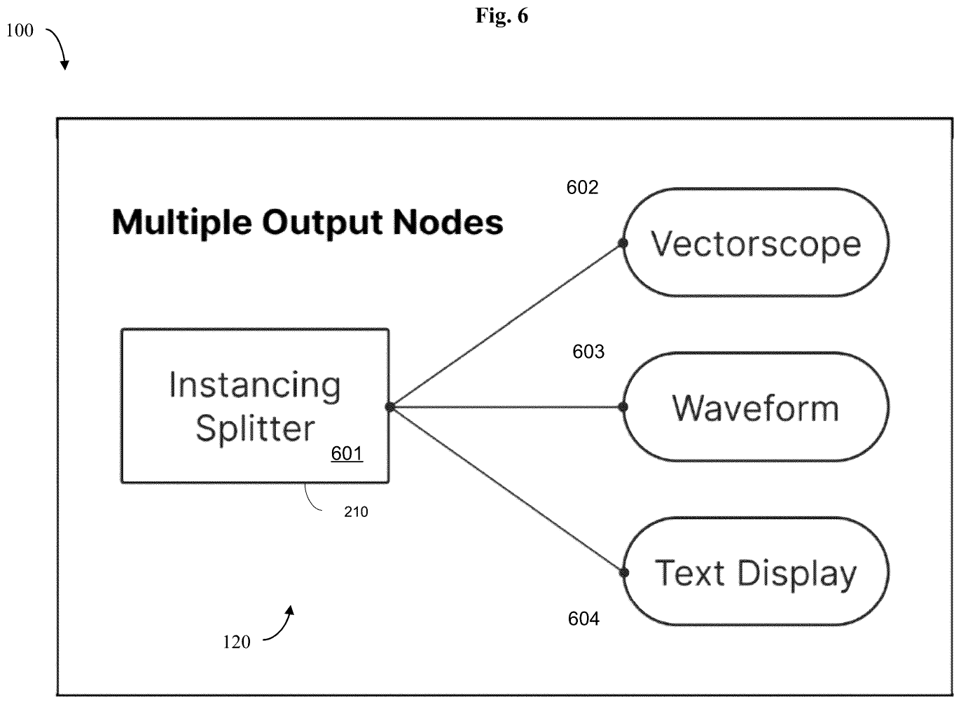

FIG. 6 shows an exemplary nonlinear effect graph 120 including a splitter node 210 with multiple outputs. Turning to FIG. 6, the splitter node 210, shown as an instancing splitter 601, creates new copies (called “instances”) of the inputted text (not shown) as needed. In this simple example, this splitter creates new instances of input for the subsequent nodes. As shown, the output of the instancing splitter 601 flows into three nodes 602-604.

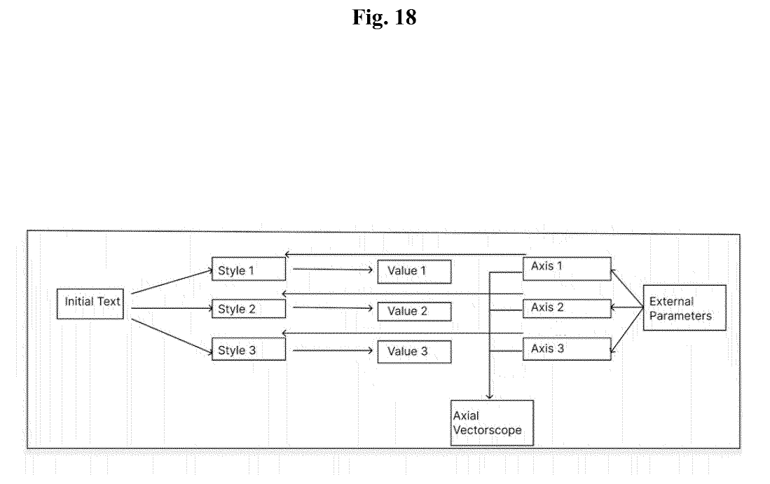

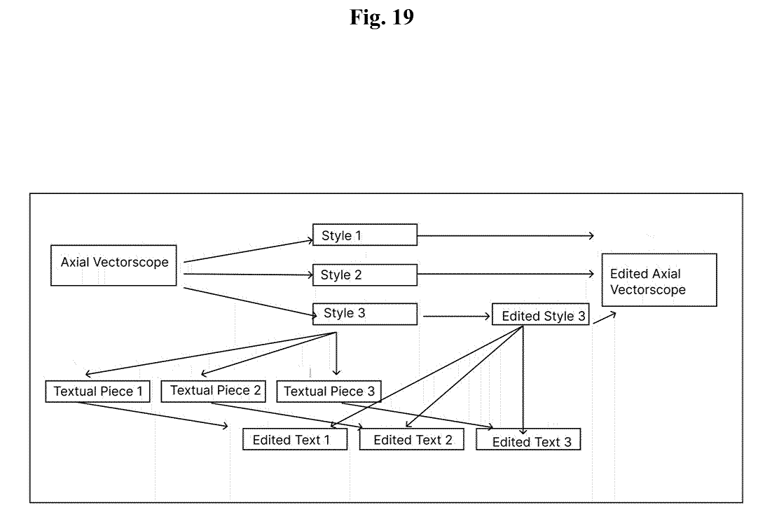

The nodes 602-604 are output nodes for visualizing the source text (including latent text), such as a vectorscope 602, a waveform 603, and a text display output node 604. The vectorscope 602 and waveform 603 output nodes are discussed with reference to FIGS. 18-19. FIG. 18 shows a 3-dimensional textual vectorscope. The selected text is parameterized according to 3 styles, which are then directly quantified as percentages. These values are in accordance with individual axes that are generated by external parameters, whether they be automatically generated or selected by the user. Examples of these values could be “casual speech,” “academic language,” or “abstract reasoning.” The generated axes form the basis of the visualization of the axial vectorscope. The direct inputs into the vectorscope become the style values where the output is the visualization itself.

FIG. 19 shows the reverse-modification where modifications to the initial axial vectorscope transform the base text. Given that the vectorscope can be analyzed as a graphical representation with a series of axes, the user can modify the values in any axis. This action detects the series of words or phrases that comprise the percentage ranking of a given axis. If the transformation is negative, a subsequence of these is transformed into neutral text. If the transformation is positive, a sequence of neutral text is transformed into stylistic text.

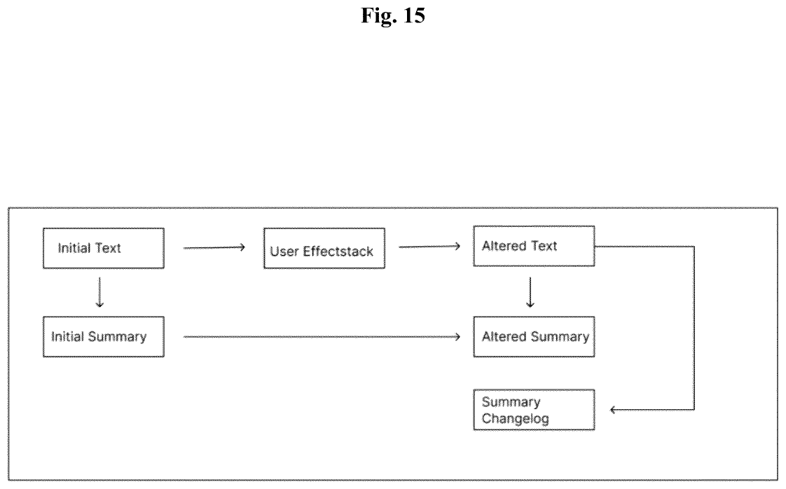

FIGS. 15-17 illustrate an elastic summary, which is another embodiment of the output nodes. The elastic summary has two sets of inputs: the initial text and external parameters. The initial text is the writing the elastic summary summarizes and the parameters are user-constructed commands for the type of summary that is created. An example of a parameter value includes the length of the summary, which can be determined up to word length by the user. After ingesting the initial writing, the text gets each parameter passed through to create the summary. The elastic summary includes at least the written section and a control panel that determines the style of the summary. As shown in FIG. 15, the control panel continues to work after summary creation. By modifying any sliders or parameter values, the user edits the summary. Notably, the source text is not altered by changes to the summary and the elastic summary is maintained and editable by the user separately from the source text.

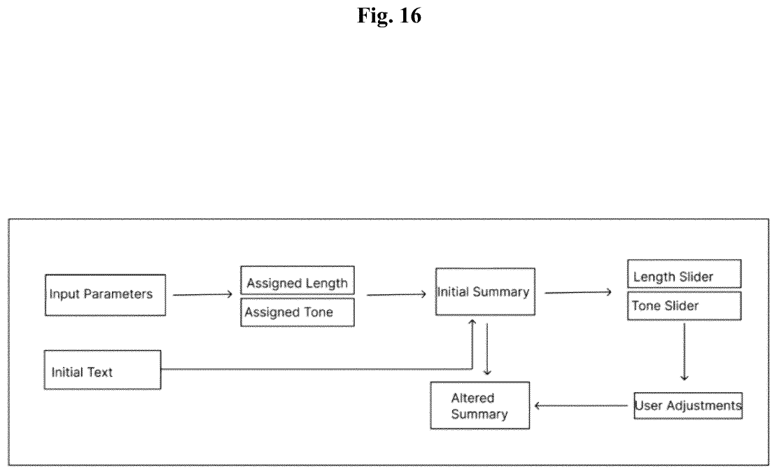

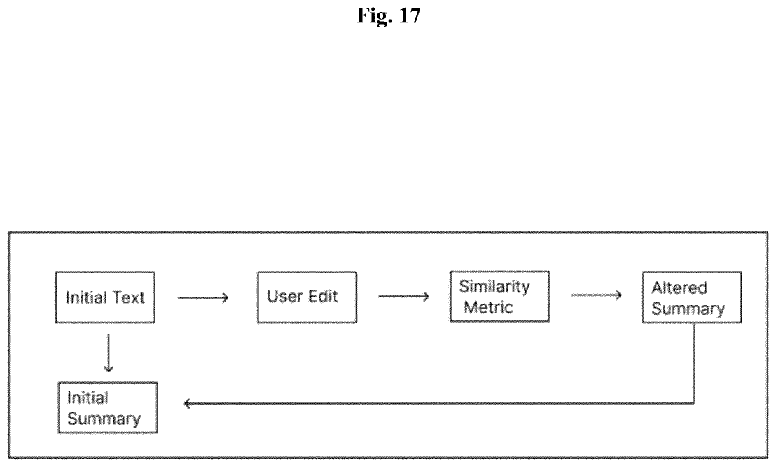

FIG. 16 illustrates one embodiment of the downstream effect of changes in the initial text altering the elastic summary created. This works with the effect stack by adding a removable, detachable effect to the initial text to apply the effect to the elastic summary as an extension of the text. FIG. 17 shows another embodiment of the downstream effect when altering the initial text through manual line edits. With each line edit, a similarity metric determines if the newly altered text is sufficiently distinct to warrant a different summary. If the text fails this check, it maintains the same summary; otherwise, a new summary is generated.

In some embodiments, each of these output nodes are being fed the same input simultaneously and can be simultaneously visualized by the user. However, the input can also be staggered into each output node as desired.

As before, the nonlinear effect graph 120 extends the linear effect stack 110. FIGS. 7-9 illustrate alternative embodiments of the linear effect stack 110. Turning to FIG. 7, the effect stack 110 takes source text 701 (i.e., the original text passed into the effect stack 110) as input, which is fed into the first effect 702A in the stack. This effect optionally takes in external parameters 704 to produce output text 703A. An example of an external parameter includes a “strength” value, or a concept to be injected into the text. External parameters can be passed into all effects 101 but are not shown as such for clarity.

This output text 403A, based on the functionality of the effect 702A, is passed into the next effect 702B in the stack, where the process repeats for all n effects. Effects optionally also output external data, which is not fed into the next effect, but can instead optionally be visualized separately. This could be an example of a “viewer,” described herein. Notably, the source text 701 is not modified by the effects, and the effect stack 110 is maintained and editable by the user separately from the source text 701. The source text 701 is also editable, updating and recalculating the downstream effects when modified.

The process described with reference to effect 702A through output text 703B repeats until the nth effect 702N, resulting in final output text 703N of the effect stack 110. FIG. 7 also illustrates a text display 707, which displays the output text 703N from the effect stack 110. This is optionally used in place of the display of the source text 701. As also shown, the effect 702B can produce external data 705. Although all effects 101 can produce external data, this example shows only the effect 702B that is not passed down the effect stack 110, but rather to an external/outside process, such as to an external display 706 for purposes of data visualization.

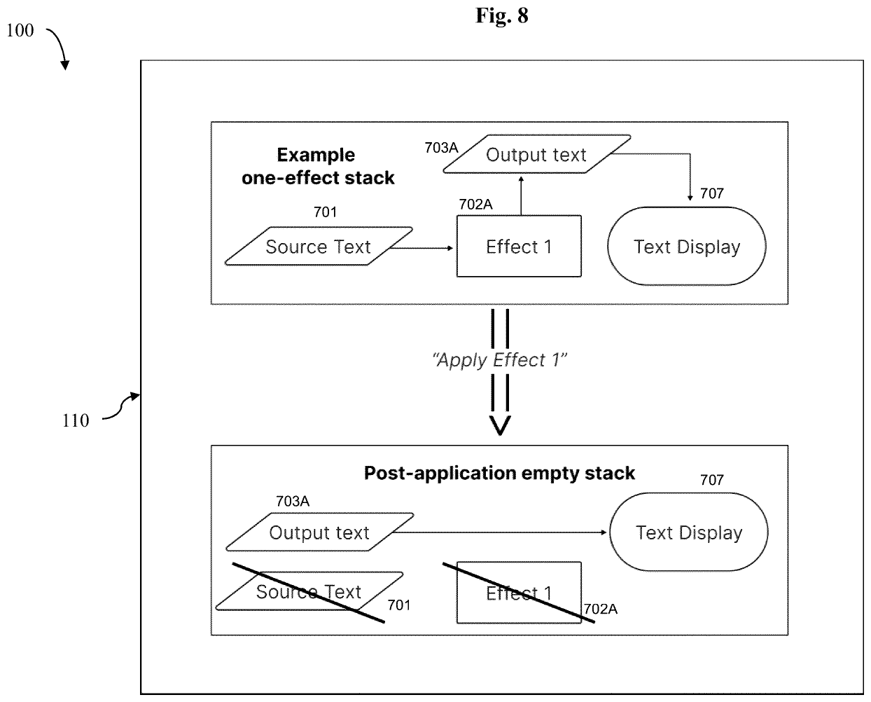

FIG. 8 illustrates an effect 101 being applied, such as the effect 702A from FIG. 7. In some embodiments, the application of the effect replaces the source text 701 with the output of the effect and then deletes the effect. This could be done to save computational resources or reduce clutter or more.

FIG. 8 shows a simplified effect stack from FIG. 7 with only one effect for demonstration purposes. The top portion of the figure represents the one-effect stack (an effect stack with only one effect) and its inputs/outputs before the effect gets applied. The middle portion of the figure represents the first effect 702A being applied. The bottom of the figure shows the effect stack 110 after the application of the effect 702A. In some embodiments, such as shown here, the output text 703A has replaced the source text 701 and is now the new source text. After the original source text 701 and first effect 702A are deleted, the effect stack 110 is empty.

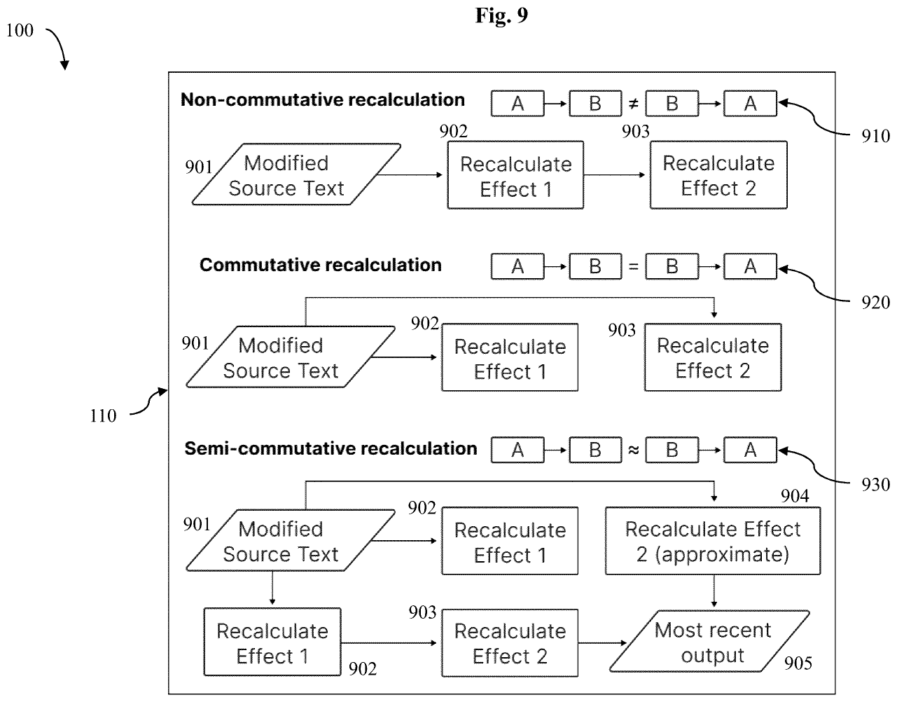

FIG. 9 describes three exemplary flow charts of how effect stacks can update based on updates to their underlying text. These same processes can occur when the parameters to the effects themselves get updated, as opposed to just the source text. This causes the same recalculations as updating the source text, isolated to effects downstream of the updated effect. Three scenarios are shown: non-commutative recalculation 910, commutative recalculation 920, and semi-commutative recalculation 930. In each example, the modified source text 901 represents source text that has been updated, thus causing the effects 101 in the effect stack to be recalculated on the new text. The process of updating the first effect in the stack is shown as processing block 902. Output text (not shown) is passed to the process block 903, which updates the second effect in the stack.

First, regarding the commutative recalculation 920, if the output of two effects in a stack are unaffected by changing their order in the stack, then the two effects are pairwise commutative. In other words, applying the first effect then applying the second yields the same result as applying the second and then the first. For example, in terms of classical text editing, accepting a spelling suggestion and then converting the text to italics would be a set of commutative operations. When this is the case, and an upstream source is modified (whether it's the source text or a prior effect), both commutative effects can begin to be calculated in parallel. This can scale to any arbitrary number of commutative effects.

Additionally, if the upstream source modified is pairwise commutative with a given effect, then that effect need not be recalculated.

Next, in the non-commutative recalculation 910, the order of effect application matters. When effects are non-commutative, downstream effects of a modification could be recalculated sequentially.

Finally, for the semi-commutative recalculation 930, the symbol represents approximately equal to because, as shown, the outputs of distinct ordering of effects are roughly the same. Here, the system can initially calculate effects as if the system was commutative, creating an approximation of the correct output while being able to leverage speed boosts of parallel processing. The system can, at the same time or otherwise, begin the slower process of sequentially updating the text (as in the non-commutative case). When this process finishes, the more accurate output can optionally replace the approximation.

The parallel recalculation of the second effect in the stack is shown as process 904, similar to the process 903. This calculation is approximate, as the effects in the stack are only roughly commutative. The most recent output 905 of the sequential and parallel calculation streams formed by the modified source text 901 undergoing the process 902, the process 903, and the process 904. While the sequential calculation stream is still being calculated, this could display the finished parallel calculation stream. Then when the sequential and more accurate stream is finished, the result can replace the prior less accurate output.

In some embodiments, the content of documents can be modified as appropriate to the users' preferences. These preferences may vary with time, context, document type, content type, content level, content style, domain knowledge, current user state (tired, engaged, on a deadline, etc.), and more. These preferences, though potentially specified by the user, may also not be directly managed or known by the user themselves, and instead set through some automatic method or a third party.

The content of a document includes the ideas the work is designed to communicate as well as the specific words (and images, audio, and video) used to communicate those ideas. With the systems and methods disclosed herein, the ideas and the means of expression can be separated and manipulated independently. Different forms of expression can be chosen that communicate the same (or mostly the same) ideas. Or certain ideas can be inserted, eliminated, expanded, compressed, emphasized, or deemphasized. Images and/or videos can be created and annotated to make concepts clearer or more engaging.

Readers can access a set of adjustable attributes to modify the document (here including text and potentially images and other rich media) to meet the user's needs and preferences. These modifications need not apply to the entirety of the document, but rather to parts of the document. These might include a reading level, conceptual density, formality, style, time available, etc.

Once a new document has been created, it can be presented to the user in a document reader, complete with customized text, images, videos, bullet points, and more-all optimized to meet the user's needs and preferences.

In addition to creating and/or presenting a document containing new text and images, a document can be created and/or presented that includes all of the original content, but with annotations (text, images, and rich media, as appropriate). As used herein, new text refers to new words generated to reflect original content and not changes to font, size, color, or language translations. For clarity, one example includes the original text and images on the right. Summaries, possibly in the form of bullets and/or images, are in a column on the left. The original content and the summaries are positioned so that the corresponding parts would be horizontally aligned (roughly).

The modified text can vary from one person's reader to the next since different people will have different parameters. Exemplary parameters can be explicitly set by the user, derived algorithmically, be packaged as a preset collection of values, or some combination thereof. That modified text, based upon a particular set of parameters (and the original text or some other text that has already been modified) can be viewed, shared, bought or sold, commented on, modified again, or voted upon.

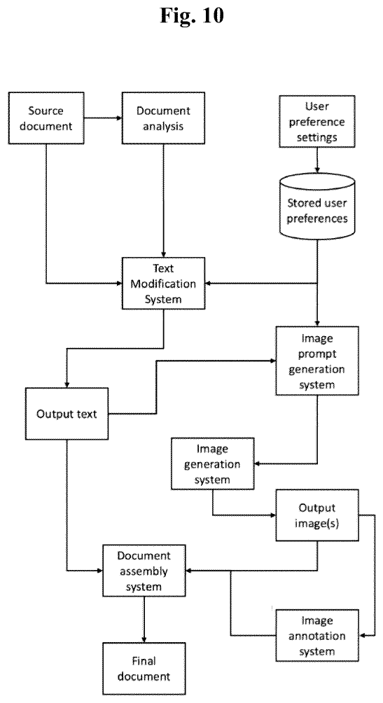

Turning to FIG. 10, a source document undergoes Document analysis. User preference settings can be set and updated through a variety of interfaces as described in the sources below, and stored as stored user preferences.

The Source document and the results of the Document analysis are passed to a Text modification system along with information from the Stored User Preferences. This Text modification system incorporates the systems and methods described herein.

The Text modification system generates the Output text. This Output text is fed onto the Image prompt generation system, which generates prompts that are fed into an Image generation system. Zero or more Output images are generated which are fed either directly into a Document Assembly system or passed to an Image annotation system before going to the Document assembly system.

The Document assembly system combines the output text, the Output images-if any, and the output from the Image annotation system-if any, into a final document for storage, transmission, and/or presentation to the user. Depending on the instance, the Source Document may also be fed into the Document assembly system (arrow not shown) to be incorporated in the Final document.

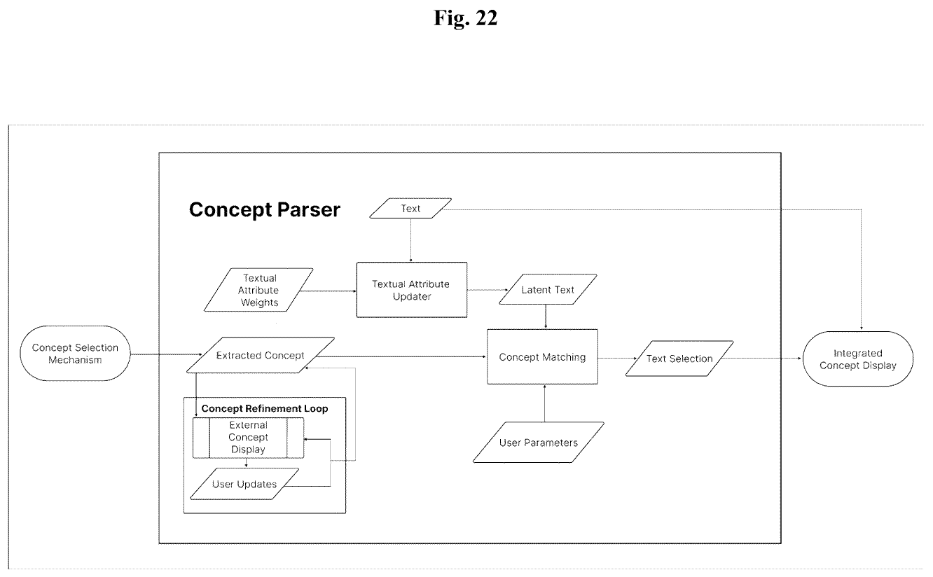

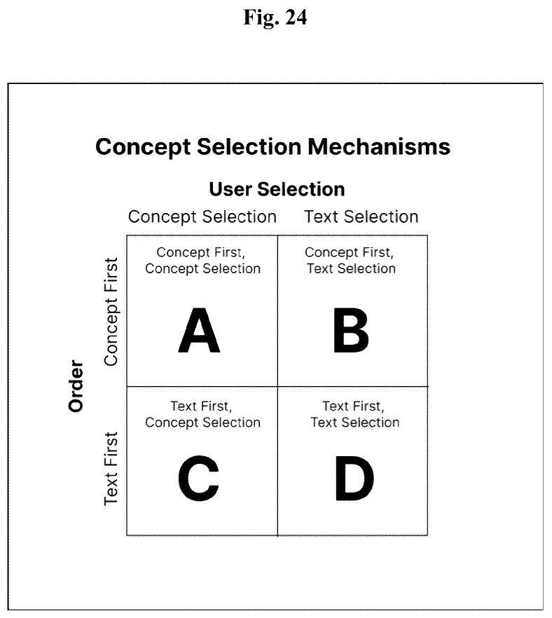

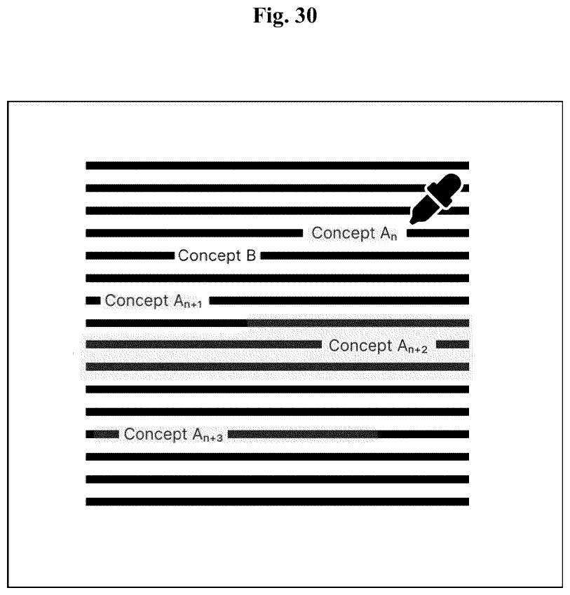

In some embodiments, FIG. 22 shows a flowchart describing a concept parser. A Concept Parser can be agnostic to a Concept Selection Mechanism (shown in FIG. 24), which provides a concept to be parsed, and an Integrated Concept Display (shown in FIG. 30), which displays the outputted selections from the parser. The job of the parser is then to take the inputted concept, refine and modify it accordingly, and then mark, identify, and or output the locations of instances of the inputted (and optionally modified) concept.

Turning to FIG. 22, a Concept Selection Mechanism is shown outputting a concept to be fed into the Concept Parser. A Concept Refinement Loop allows the user to iteratively refine the concept chosen by the Concept Selection Mechanism. This Concept Refinement Loop externally displays the concept (meaning separately from the source text) and allow the user to modify it, through use of natural language to modify a description of the concept, requesting a re-extraction of the concept that would be done in an incrementally different manner, or choosing auto-generated modifications of the concept.

A Textual Attribute Updater inputs text and a set of textual attribute weights and updates the inputted text accordingly. This updated and outputted text is denoted “latent text.” In the example shown, the textual attribute weights are specified to neglect (weight 0) all textual attributes besides the conceptual content of the text, thus isolating the concept.

Textual attribute weights are inputted to the Textual Attributes Updater to isolate the specified concept from the inputted text and produce the latent text required for the Concept Parser to function.

The latent text output from the Textual Attributes Updater is not necessarily comprehensible to humans and may only exist as a point (or set of points) in a high-dimensional space of continuous (or discrete) textual attributes.

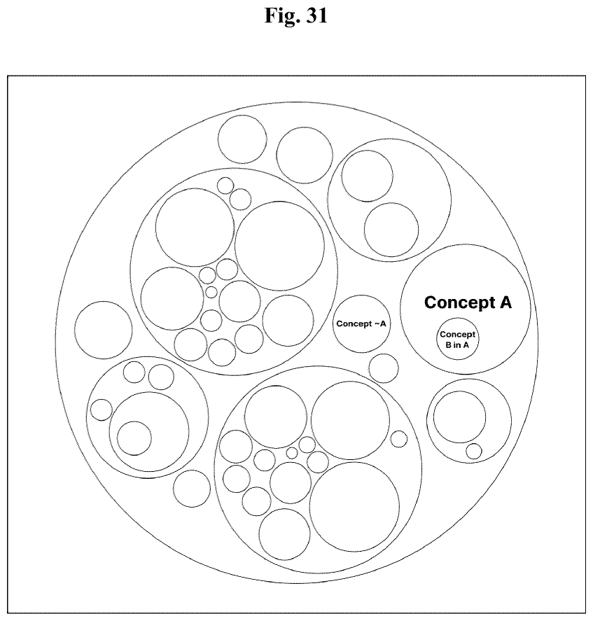

FIG. 22 shows matching the extracted concept outputted by the Concept Selection Mechanism to locations in the latent text. This Concept Matching step also has user parameters as input, allowing the user to modify the Concept Matching Process. One such parameter could be “tightness,” which is described with reference to FIG. 31.

Item 1G is the outputted text selections-locations of concept matches in the source text—from the Concept Matching process.

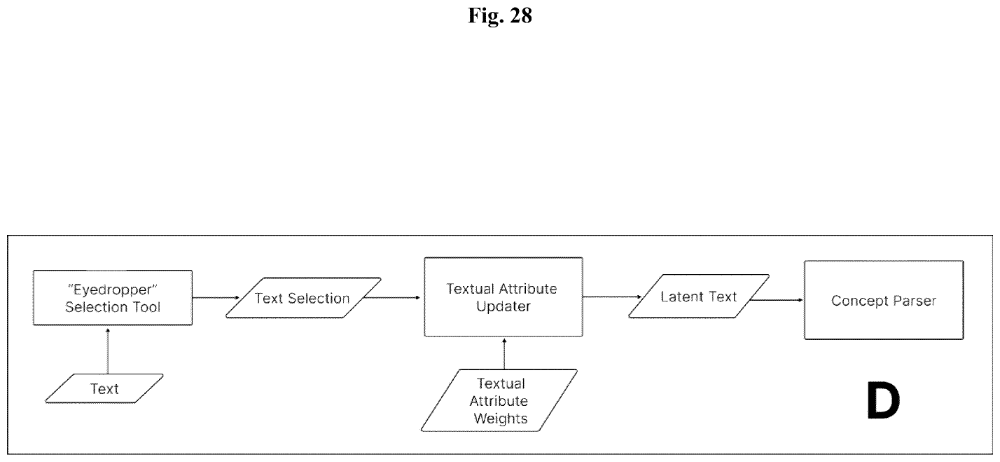

An Integrated Concept Display can display the concept integrated back into the source text. This display can have the original text as input as well as the text selections generated by the Concept Parser, allowing for the display to optionally display the selections as an overlay on the source text. A possible Integrated Concept Display is shown in FIG. 28.

Optional user parameters can be passed into the Concept Matching process. These user parameters can modify how the process operates. Non-limiting example parameters are further discussed in FIG. 31.

The original source text that the Concept Picker gets converted to latent text so that the Concept Matching process can compare it to the extracted concept. The target concept output from whatever concept selection mechanism is used is shown as producing an extracted concept, such as a form of latent text. This extracted concept latent text can be compared to each section.

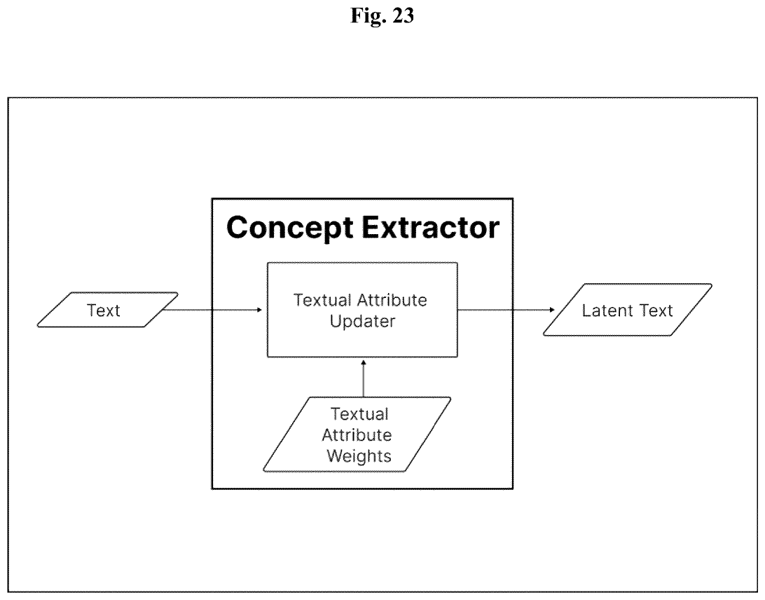

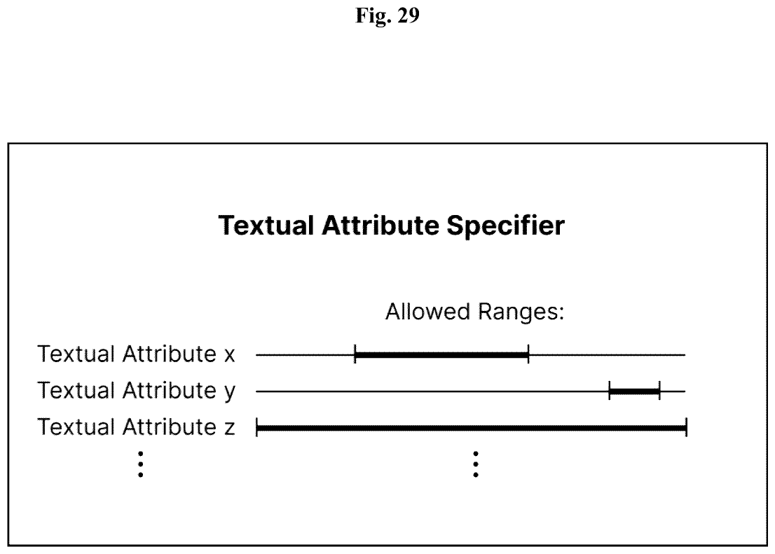

FIG. 23 illustrates a Concept Extractor to extract the concepts from the input text and produce latent text which represents these concepts. By modifying the Textual Attribute Weights, the Concept Extractor can be generalized to an extractor across any set of ranges of textual attributes. This functionality is further described in FIG. 29. The latent text produced by this Concept Extractor can be used to compare to a given concept. This latent text can importantly preserve its original location as non-latent text, allowing location-based projection back onto the source text for purposes including but not limited to various visualizations.

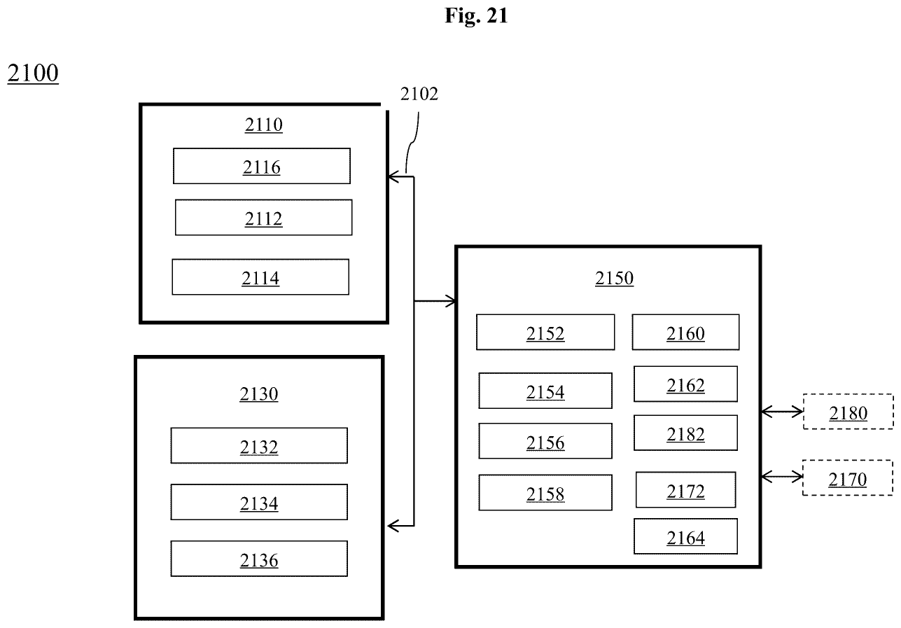

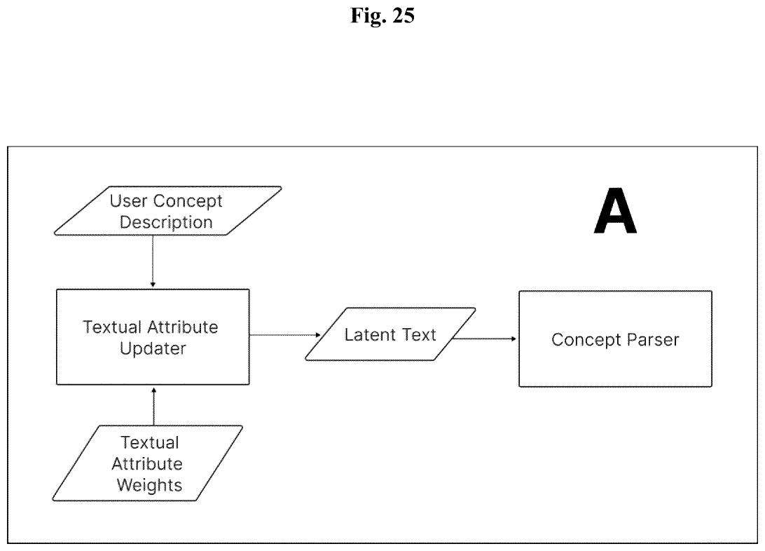

FIG. 24 provides an organizational structure for four Concept Selection Mechanisms (FIG. 21 is not limited to these four mechanisms). For example, a mechanism with cross-media functionality that allows importing concepts or other textual attributes from other forms of media such as images). FIGS. 25-28 illustrate each Concept Selection Mechanism.

FIG. 25 illustrates the first of these four Concept Selection Mechanisms from the first quadrant of FIG. 24, meaning it is a concept-first concept-selection. This means that the process starts with a concept—as opposed to starting with the text—and then the user selects a concept—as opposed to selecting a part of the text.

A User Concept Description, which is a description of the target concept provided by the user, is shown. This description can be natural language.

FIG. 25 also shows that user concept can be used to convert the User Concept Description to latent text that can be compared to sections of the latent text inputted into the Concept Matching process inside the Concept Parser. Output text selections (1G) are fed into an Integrated Concept Display.

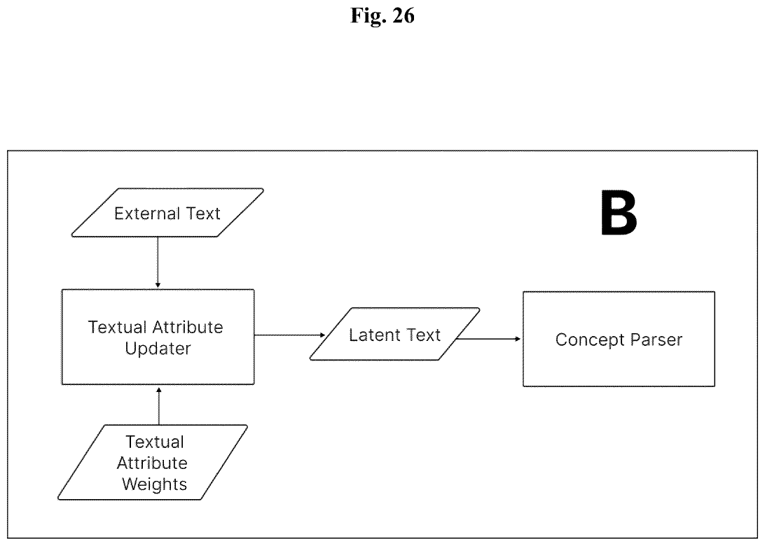

FIG. 26 illustrates a concept-first text-selection Concept Selection Mechanism of FIG. 24. In this mechanism, external text is provided which contains the concept as opposed to a description of the concept itself generated to be used specifically for the purposes of the Concept Picker. This can be equivalent to using the text-first text-selection mechanism described in FIG. 28 on a piece of external text, meaning not contained in the source text in the document being edited. Otherwise, FIG. 26 is equivalent to FIG. 25.

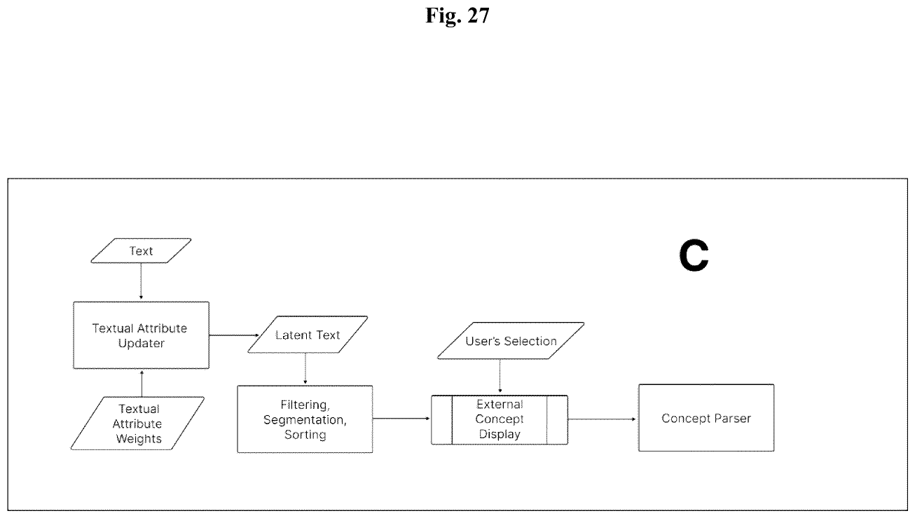

FIG. 27 illustrates the text-first concept-selection mechanism in the third quadrant of FIG. 24. This Concept Selection Mechanism first sources candidate concepts from the text, hence being text-first. Then, the user can select one of these concepts from an External Concept Display, an instance of which is described in FIG. 31.

With reference to FIG. 27, a filtering, segmentation, and sorting process is shown that converts the latent text to a set of concepts to be inputted into the External Concept Display, from which the user can make a selection. This filtering can remove and/or downgrade unwanted or unnecessary concepts to display. This segmentation can segment the concepts in the text based on different granularities. This sorting can order the concepts based on some set of criteria, a non-limiting example could be frequency or importance.

An External Concept Display displays the concepts outputted externally from the source text. Examples of these displays could include (but are not limited to) a clustering of concepts, a list of concepts, or a hierarchy of concepts. The user's selection of the concepts can be shown, ultimately choosing the concept inputted to the Concept Parser described FIG. 22.

FIG. 28 illustrates the text-first text-selection mechanism in the fourth quadrant of FIG. 24. This Concept Selection Mechanism allows the user to select a portion of the source text-similar to how an “eyedropper” tool works in digital media editing software—and extracts the concept from the selected section of the source text. It is otherwise similar to previously described Concept Selection Mechanisms. A tool used for selecting a section of the source text that contains the target concept is shown. This non-limiting example utilizes the “Eyedropper” selection tool illustrated further in FIG. 30.

FIG. 29 illustrates a non-limiting example of a Textual Attribute Specifier, which allows the specification of a set of ranges along a set of textual attributes. The Concept Picker's functionality can be extended with this set of ranges to pick out any text that falls within these ranges, just as it could pick out any text that falls within the concept picked (optionally modified by parameters including but not limited “tightness” described further in FIG. 31). A non-limiting example is selecting text that is only of a certain style, or is sufficiently technical, or is of a certain style and not sufficiently technical, and etc.

FIG. 30 provides a non-limiting example of the use of an “eyedropper” tool, which could be used in the mechanism described in FIG. 28. The highlights in this example are additionally a non-limiting example of an Integrated Concept Display. The black lines represent a chunk of source text. An eyedropper tool is shown, which could be controlled by the user to select a certain part of the text. In this non-limiting example, it is hovering over Concept Aₙ, which is the nth instance of some concept denoted Concept A.

A highlighted region containing Concept Aₙ₊₂, which is the n+2′th instance of Concept A (the instance of Concept A after its next instance). Note that the entire region discussing or containing or otherwise relevant in some specified way to Concept A is highlighted. Additionally, note that Concept B (a concept distinct from Concept A) is not highlighted.

FIG. 31 shows an example of an External Concept Display. In this example, circles (called “bubbles”) represent concepts found in the text. They can be clustered according to similarity. The size could (but is not limited to) represent the prevalence of the concept in the text, or the importance of the concept, or etc. Bubbles inside of other bubbles represent sub-concepts, in which one concept is contained within the other. Bubbles overlapping bubbles can indicate overlapping but distinct concepts. The dimensionality of these relationships can easily exceed the capacity for 2D representation. As such they can be represented with a variety of techniques to represent multidimensional spaces.

This figure provides a good surface on which to describe the “tightness” parameter. A tightness value would specify how similar a concept would need to be to the chosen concept to still qualify for selection. For example, Concept ˜A (a concept roughly the same as Concept A) may be selected as well as Concept A with a non-zero tightness value. This tightness value could expand to cover an ever-broader area increasingly dissimilar to the original chosen concept, or be maximally tightened to only cover Concept A or even only a subset of Concept A. And, of course, “tightness” can also be reflected in the UI with concepts that are “tighter”, or “looser” being differentially represented.

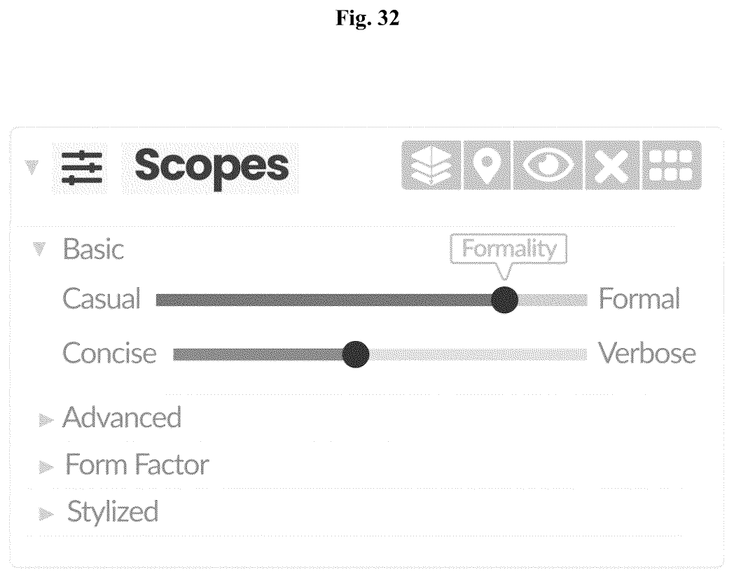

Additionally and/or alternatively, FIG. 32 shows an example interface for text editing based on continuous text modification. The example exposes continuous sliders—in this case a “formality” slider and a “conscision” slider-allow the user to modify the formality or concision of the text. This is similar to how a user would modify the saturation value of an image based on a saturation slider. This particular example interface groups multiple sliders into groups (such as “basic” and “advanced”), and places the sliders in an effect called “scopes” which is itself located as an effect in an effect stack. These sliders can modify any textual attribute. In addition to sliders, other interfaces can include knobs, selecting a point in 2 or 3 dimensions (on a surface or in a volume) in order to adjust 2 or 3 parameters simultaneously, up and/or down arrows that can be used to move discreetly through a continuous space, and so on.

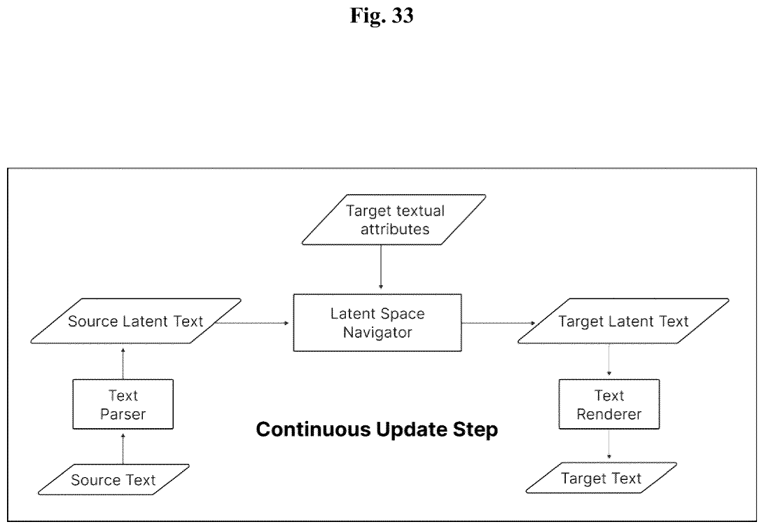

FIG. 33 describes an update step in the continuous text modification paradigm. This can be used after a user interaction (such as with a slider) updating a textual attribute of text, and labeled as source text. This update step first involves passing the source text into a text parser, which converts it into latent text. This latent text is passed into a Latent Space Navigator (LSN), as are the target textual attributes. The LSN navigates the modified textual attributes of the source latent text based upon the target attributes, producing the target latent text. This target latent text is then rendered back into text by a text renderer, finally producing the target text. The source text refers to the text pre-update, or pre this update if there are multiple iterations of the updating process. The text parser parses the text and converts it to latent text. The output of the text parser is the latent text corresponding to the source text.

The Latent Space Navigator (LSN) navigates from an input source text in the context of a set of target textual attributes, thus producing the target latent text. This navigator can optionally take in user parameters which modify its navigation, or output incremental steps along its navigation, or more. The target textual attributes can be selected by a user interface, one of which can include a slider modifying one or more of the textual attributes of the source text. The output of the LSN is the representation of the target text in latent space.

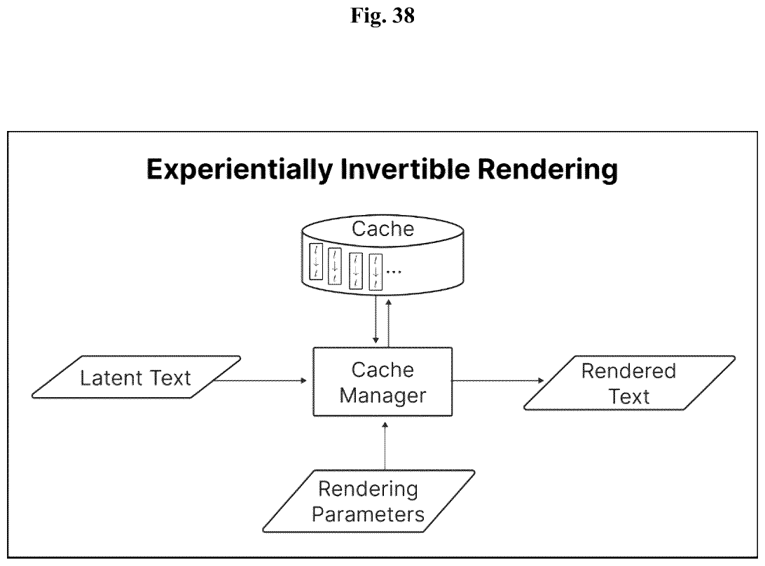

The text renderer converts the latent text representation to the target text. This “rendering” can be analogized to rendering in digital media creation. The process behind this is discussed further in FIG. 38. The target text is the text post-update with the modification applied.

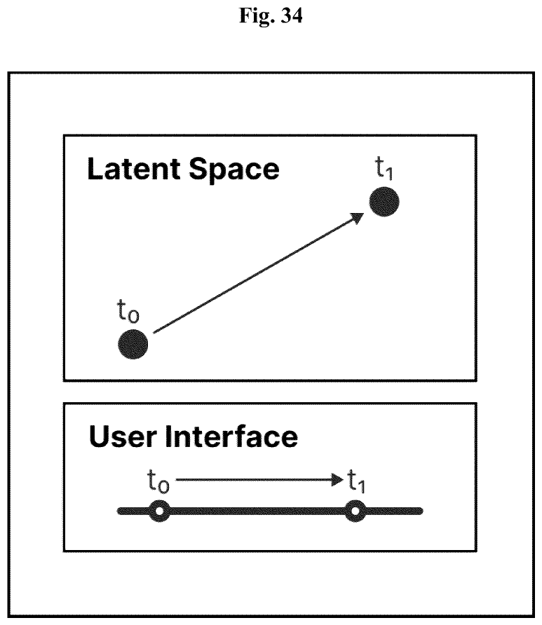

FIG. 34 illustrates the connection between an example of a user interface and how the text is modified in latent space (the system's internal text representation containing the underlying text dimensions discussed above). Here, the example interface is a slider, with the user moving the slider from t0 to t1. This slider—while potentially displayed to the user as a continuous textual attribute such as “understandability”-moves the text in the latent space (not necessarily along a single dimension). In this figure, the latent space is simplified from its vast dimensionality to only two dimensions for the sake of illustration. In use, the text is likely moving in a dimensional space much higher than two.

The original representation of the latent text is visualized as a dot labeled t0, which is then navigated to the dot at t1 along a vector corresponding to the textual attribute that the slider controls. The arrow pointing from the pre-modification source text to t0 the post-modification target text t1 can be thought of as getting projected down onto the slider.

Although shown as a simplified representation of the latent space, only two dimensions are shown for the sake of simplicity. Two dots are drawn in this latent space, representing the text before and after it gets modified. Certain textual attributes of these two pieces of latent text correspond to the locations on the slider, which is an example of a user interface that exposes vectors in this latent space to the user. The user interface is shown with a slider. This slider can correspond to a textual attribute of the text, such as concision or formality.

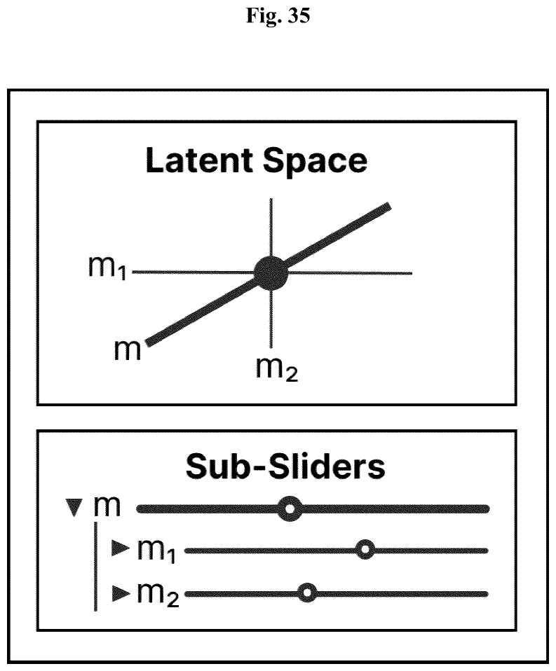

FIG. 35 shows a possible extension of the concept of a textual attribute slider, further illustrating the power of exposing the underlying dimensionality of text to users. In this example, a single slider modifying some textual attribute (called “m”) can optionally be expanded to show multiple sub-sliders (“m1” and “m2”). It is likely that textual attributes that are semantically useful for the user exist along a collection of dimensions in the latent space, or along some other more complex topology. Sub-sliders allow the interface to “break open” these mixed dimensions or complex topologies into different sliders, allowing finer control to the user. These sub-sliders may correspond to ineffable qualities of the text, but nevertheless still offer control. These sub-sliders themselves can be of arbitrary granularity, optionally being able to be expanded themselves.

The ordering, creating, naming, and recommending of these sub-sliders are also within the scope of the described systems and methods. In the illustrated example, the two sub-sliders, m1 and m2, correspond to the “x” and “y” axes in this simplified latent space (m1 and m2 in 4A above it) while the parent “m” slider moves diagonally along the space. To describe the concept in a more technical manner, if the slider “m” is moving along some vector represented as a linear combination, root-level sub-sliders can be thought of as shifting the individual coefficients in this linear combination. Of course, sub-sliders can themselves correspond to more complex topologies or vectors existing in higher dimensions, able to be further broken down into sub-sliders themselves in a sort of tree structure.

The top portion of FIG. 35 the simplified illustration of a latent space, containing a piece of latent text (represented by the dot) and three highlighted vectors labeled “m,” “m1,” and “m2.” The parent vector “m” can be broken into component vectors by the other two labeled vectors “m1” and “m2”.

The bottom portion of FIG. 35 is an example of a possible slider interface exposing the parent vector and its component vectors to the user for modification. This interface shows a dropdown button to the left of the slider labels, allowing the user to expand sliders and reveal (or request the creation of) sub-sliders or other interface elements providing access to the component vectors.

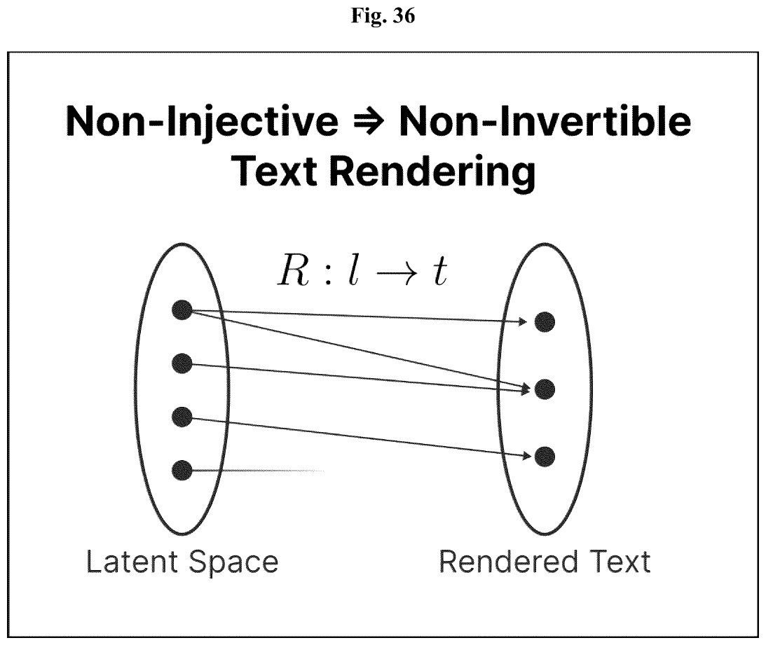

FIG. 36 illustrates some of the nuances in the text rendering process, shown in FIG. 33. FIG. 36 shows how rendering text-referred to with the notation R (1), where 1 is a piece of latent text—is non-bijective. In other words, there is not a direct mapping between every instance of latent text and every instance of rendered text. For notations sake, instances of latent text are referred to as LT and instances of rendered text as RT. Instead, in practice, this rendering process may be more “fuzzy,” and there might exist: multiple RT for a LT (multiple similar renderings of a single piece of latent text), multiple LT for a RT (possibly due to the inherently finer granularity of the latent space, meaning multiple locations more similar than the granularity of rendered text would have the same rendering), or no RT for a LT (some latent text cannot be effectively rendered).

An example of a piece of latent text with no textual rendering is a piece of latent text containing only text style information. This piece of latent text would be useful computationally, for use in operations on other pieces of latent text, but is not itself able to be rendered into text. These nuances mean that the text rendering process is not invertible, meaning that the projection back into latent space will not necessarily produce the input to the render process. One can imagine iteratively rendering and then un-rendering (projecting back into latent space, referred to as “parsing” herein), slowly accumulating differences from the fuzzy mappings. This behavior may not be desirable, as a user moving a slider back into a previous location should produce the text previously at that previous location assuming no other edits have been made. Additionally, if the user moves the slider back to a distance within the granularity of rendered text but not within the granularity of latent text, the latent text could begin to drift eventually affecting the rendered text. This possibly undesirable behavior is addressed in FIG. 38.

FIG. 36 illustrates text in the latent space. A rendering function, shown to be mapping from “1” to “t” (latent text to text) produces text in the rendered text space. A failed rendering process is shown at the bottom of the latent space, where a piece of latent text has no representation as rendered text.

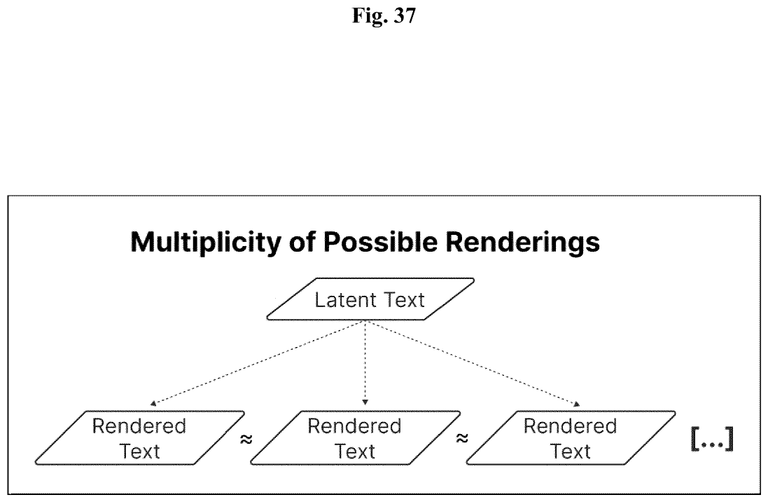

FIG. 37 shows a flowchart of how a single piece of latent text could be represented as multiple pieces of rendered text. Here, the rendering process is shown as dotted lines, representing how they are potential renderings as opposed to produced renderings. These potential renderings are all roughly equivalent, as symbolized by the “approximately equal” signs between them. As shown, the possible renderings of the latent text are all pairwise approximately equal.

FIG. 38 shows one embodiment that would make this fuzzy, non-invertible and nuanced rendering process experientially invertible, providing the user with an experience as if the rendering process was invertible. It works by caching previous renders and parsings which are chosen to be used, if possible, thus consistently choosing a rendering or parsing of a given piece of latent or rendered text. The cache manager could also input certain rendering parameters, one of which could be a “granularity” parameter. Based on this granularity, the cache manager could choose to use previously cached renders or parsings based on the similarity of the cached mapping to the current mapping at hand. This could speed up performance, as well as provide a much-improved user experience by creating consistency between subtly or imperceptibly different target textual attributes. This cache could also be optionally shared across sessions, users, or interfaces and apps.

The cache manager manages the cache and is responsible for searching through the cache (based on the rendering parameters), updating the cache, and otherwise maintaining it. If the requested mapping is not in the cache, the cache manager would need to manage generating it. This functionality is encompassed in the cache manager for the sake of diagrammatic simplicity. The cache (possibly but not limited to being a vector database) stores prior mappings. Thus, if a given segment of latent text is being rerendered, instead of possibly producing a text similar to the previously rendered version, the cache can simply provide the previously rendered version. The cache can also store and provide a similar but not identical mapping to be used based on the rendering parameters.

Rendering parameters can include granularity (required similarity for selecting a previously cached mapping), fidelity, engine type, noise values, temperature, whether or not to use the cache (allowing for “rerolls”), or more.

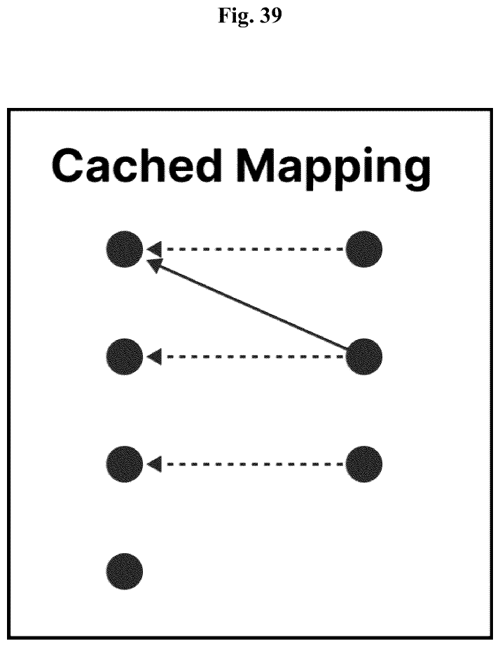

FIG. 39 is a simple illustration of how this cached mapping could occur in the medium of a mapping diagram. Here, the dotted arrow represents possible mappings, while the solid arrow represents a cached arrow. Note the inversion of arrow directionality from FIG. 36. This is meant to illustrate how cached mapping could occur in both directions-once a piece of text is rendered into latent text, converting that text back into latent text could use that same cached mapping, just as rendering that same piece of latent text again would use the cached mapping. Essentially, the solid arrow mapping path has been chosen, thus optionality eliminating the undesirable behavior discussed in FIGS. 36-37.

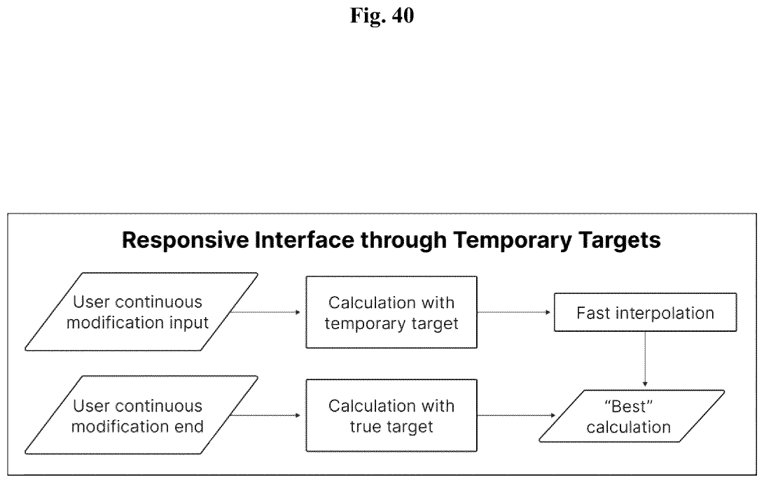

FIG. 40 describes an exemplary flow for a responsive continuous text modification interface even in the face of slow parsing and rendering steps. It combines two major components: a temporary target, and a fast interpolation algorithm. This temporary target could be created or selected while the user is providing continuous modification input (an example of this would be starting to slide a slider). The temporary target (which could be the predicted target of the modification, a reasonable upper bound for the textual attribute that corresponds to the user's modification, a close-by precalculated value, or cached previously calculated values) could be used to display an intermediate approximation of the target text at the current textual attribute value. This target could be interpolated to with a fast interpolation algorithm, the progress of which can be dictated by the distance of the slider value to the temporary target. Then, when the non-fast interpolation algorithm result is done being calculated, it could replace the interpolation to a temporary target-based result.

A user provides a continuous modification input. A non-limiting example of this is the segment of constant motion in the process of moving a slider value. The text calculation is shown with a temporary target. A temporary target is not the true target because—in the example—the user has not finished moving the slider value yet. However, a continuous experience can be provided to the user. The rendering and parsing processes may be too slow to operate on the timescale of a segment of a user's slider move, however, and thus we can make use of the temporary target.

A fast interpolation algorithm interpolates between a temporary location and a temporary target, to provide a much faster approximation of the true target text. A non-limiting example includes traversing an edit tree based on the slider's distance to the temporary target.

The end of a user's continuous modification includes finishing moving a slider value. Once this end occurs, the calculation of the target text can occur (presuming that it does not match closely enough with the temporary target, or was not calculated prior or began to be calculated prior with a predicted target). The calculation with the true target, which is known once the user ends their continuous modification edit, is also shown.

The best calculation for the current values, which is either the fast approximation-based interpolation method, or the calculation with the true target is produced. This result is optionally displayed to the user, thus providing an approximate responsive interface. This diagram also covers the use of calculating with predicted targets, meaning that the true value could already be calculated by the time the user moves the slider to their end value.

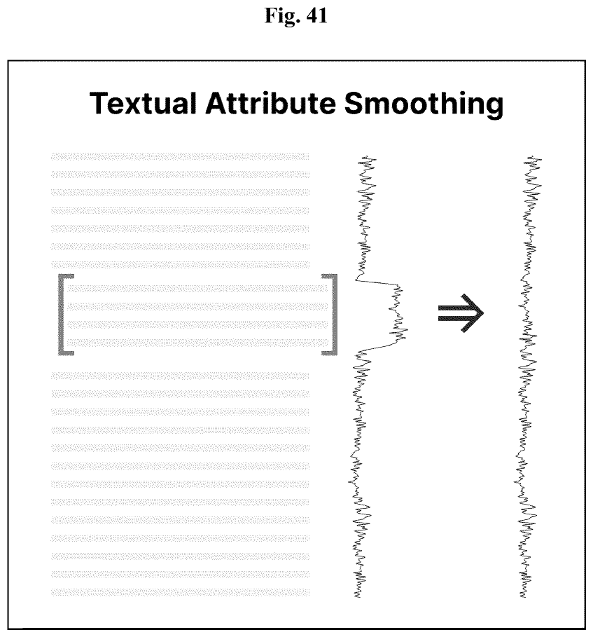

In some embodiments, FIG. 41 provides an example of how smooth editing can apply in a common use case: text insertion. While smoothness can apply to any set of textual attributes, in this case only one textual attribute is visualized in the form a line-plot along the right side of the example text. Multi-dimensional smoothness is desirable when one may want how technical a piece of text is to match the rest of the document, as well as the style. Other times, the editor may not mind a certain section of the text being more technical, while still desiring to maintain stylistic consistency. In this illustration, the text wrapped in square brackets represents an inserted segment of text, and the visualized textual attribute of the inserted segment is significantly higher than the text it is being inserted into. The smoothing process would thus “smooth” out this bump, maintaining consistency across the inserted segments surroundings. This smoothing could work by modifying the existing text (through textual attributes or otherwise), deleting segments of the text, or adding in new segments of text, or more.

As shown is a section of a document, which provides the context that our smooth editing can occur in. The brackets represent an inserted segment of text. A possible graph of a given textual attribute of the text can be shown for illustration. Note that this graph may have small fluctuations in the non-modified sections of the text. In this example, the inserted segment differs drastically along this textual attribute, as can be seen through the bump in the graph next to the text to be inserted.

The arrow represents the smoothing process, taking the before state of the graph on the left to the after-state graph on the right. In other words, the graph on the right is the same graph of the given textual attribute after the smoothing process has occurred. Note that the bump present in the left is no longer present, and has instead been “smoothed” out.

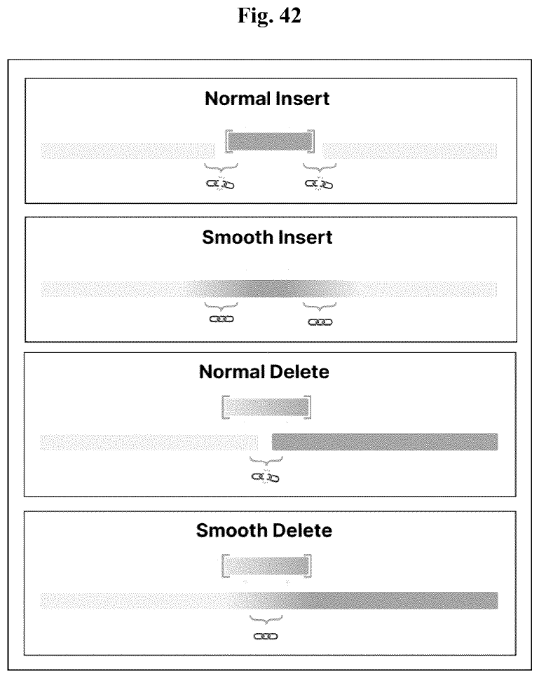

FIG. 42 furthers this notion of smooth editing. It shows the distinction between normal insertion/deletion and smooth insertion/deletion. Note that the arrows represent the direction of editing (moving into the text or out of the text), the darkness of a text segment represents the segments placement along some textual attribute, the broken chain link represents a grammatical or “flow” break, and the intact chain link represents no break in grammatical correctness or flow. Note that the examples presented in this figure do not cover all the possible instances of smooth editing. Other non-limiting examples include (but are not limited to) text reordering or text post-processing.

As shown in FIG. 42, for the normal text insertion case, an example includes how most modern common text editors treat pasting text, such as Google Docs, Microsoft Word, or Visual Studio Code. The normal treatment simply inserts the text section into the target text. Some of the text editing software allows a “paste without formatting” option, which pastes the characters of the text while automatically matching the formatting surrounding the text. The disclosed smooth editing allows the generalization of this behavior to non-visual textual attributes, such as style, formality, or tone.

In the first example, a segment of text is being inserted into the text. Note that the text segment is darker, indicating that it falls farther along some given textual attribute than the lighter segments it is being inserted into.

For the normal insert and normal delete, the junctions between the inserted text and the document text is shown as two broken-chain symbols representing grammatical or text flow disruptions that are commonplace when inserting text.

The smooth counterpart to the normal insertion discussed in the first example is shown in the smooth insert and smooth delete examples. This smooth insertion-unlike normal insertion-does not generate any sudden breaks in the visualized textual attribute, grammar, or flow.

In the second example, the arrow refers to the smoothly inserted segment, which cleanly blends into the text it's being pasted into. This would be the smooth counterpart to the inserted segment of the first example. The junctions between the inserted text and the document text is also shown in the second example; however in the smooth case, no grammatical or flow breaks are created. This item is the smooth counterpart of the insertion of the normal insert or normal delete.

The third example shows how deleting a segment of text may cause breaks and inconsistencies in a similar manner to inserting a text. In the deleted segment of text, the segment provided a clean transition in the text, meaning its removal leaves a break in need of remedy. Normally, this would be done manually, while in the smooth case, it is done automatically.

The last example is the smooth counterpart to the third example. This smooth delete leaves no break or discontinuity between the two newly-adjoined sections.

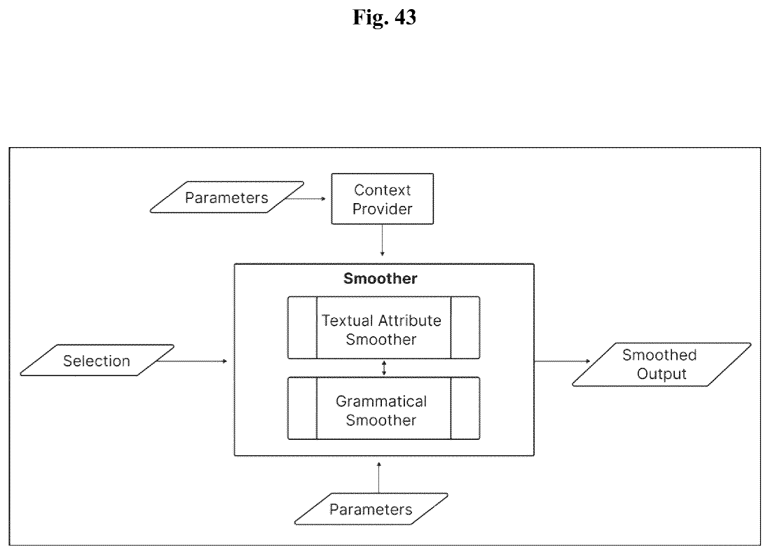

FIG. 43 illustrates one exemplary process for achieving this smoothing. This smoothing process can be changed based on a set of parameters, optionally modifiable by the user. This smoothing process can ensure grammatical smoothness as well as textual attribute smoothness. A selection of the text to be smoothed can be automatically fed into the smoother when text is inserted, deleted, reordered, otherwise modified, or more.

A smoother module includes both a textual attribute smoother and a grammatical smoother. This smoother takes the text selection segment as input, as well as context from a context provider (discussed herein) and a set of parameters. These parameters can include a smoothing type (blend, match average, moving average, or other smoothing techniques), a smoothing factor, an allowed smoothing distance, a set of attributes to smooth, or more. The input given by the context provider allows the smoother to work intelligently based off of the context surrounding the selection, being able to (as a non-limiting example) measure a baseline value for textual attributes.

A textual attribute smoother, which (as its name implies) handles the smoothing of textual attributes. A grammatical smoother can be similar to a textual attribute smoother, and a distinction is made in this drawing only for the sake of clarity. This grammatical smoother can ensure proper “linking” between newly-adjoined sections, such as when a piece of text is deleted. This “linking” refers to textual flow, grammatical correctness, or any other non-visual aspect of text that should (or could) be maintained across two segments.

Parameters are optionally passed into the smoother module, and optimally modified by a user. The now smoothed output of the smoother module is partially based on the context provided, which outputs the necessary context for the smoother module to function. By way of example, this context provider could provide the surrounding sentences of the text to the smoother, giving the smoother a target to smooth to or an additional section to modify to ensure smoothness.

The optional set of parameters (optionally user modified) are passed to the context provider. These can dictate the behavior of the context provider. An example of a parameter is outlook distance, specifying how far out from the inserted segment the context provider should cover.

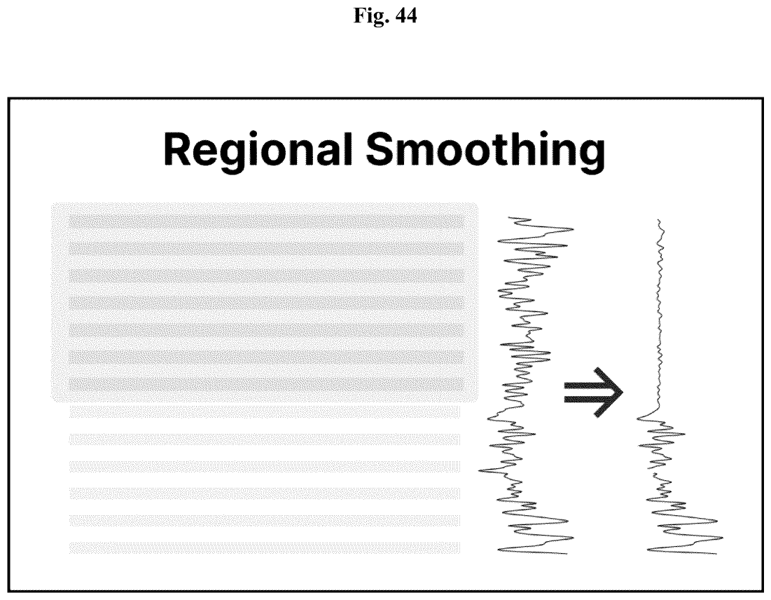

FIG. 44 shows one exemplary process for regional smoothing. Smooth editing can occur in sections without recently edited text, such as the absence of any sort of deletion, insertion, or recording. Instead, smooth editing can also be helpful in a section of text which is itself internally not smooth (or could be smoother). In this example, a region of the text gets smoothed, as indicated by the smoothed graph of a given textual attribute to the right of the example text.

As shown, a selected region that the regional smoothing is applying to is represented as a translucent gray box. The graph of the given textual attribute of the text is itself not smooth prior to correction. The graph of the given textual attribute after the regional smoothing effect has been applied is shown on the right.

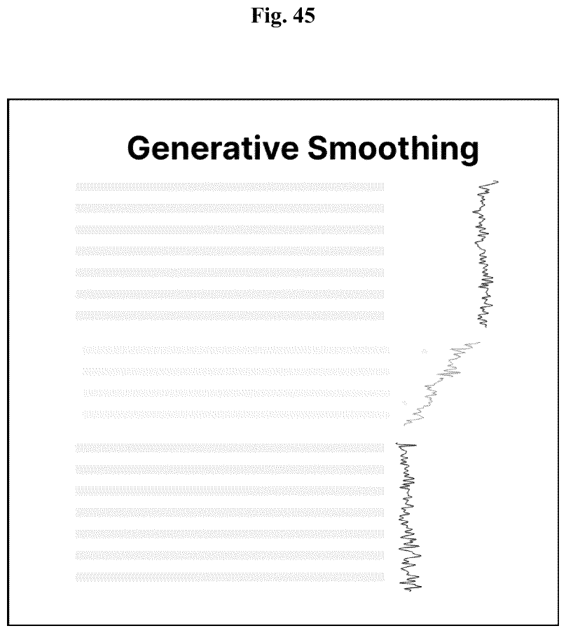

FIG. 45 shows another type of smooth editing, called generative smoothing.

Generative smoothing can be used for bridging two sections of text that have some kind of break, whether it be some grammatical difference, conceptual difference, or along some other textual attribute. Generative smoothing would generate a bridge between these two sections. This can be thought of as a kind of cross-dissolve for text.

The top graph of a given textual attribute of the section of text before the generated segment is shown. Note that this segment—while internally smooth—is at a different baseline level than the segment of text after the generated segment. The bottom graph is shown after the generated segment. The corresponding graphs of the generated segment is shown in the middle of FIG. 45. The graph of this segment bridges between the top graph and the bottom graph, providing a smooth transition. This transition could (but is not limited to) follow any sort of interpolation curve, such as linear, sigmoid, elastic, cubic, or more.

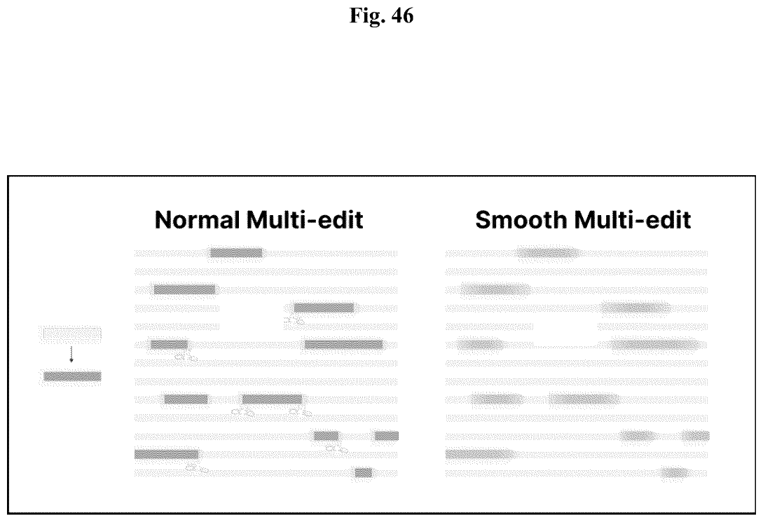

FIG. 46 shows how smooth editing could apply to a multi-edit, such as (but not limited to) a find a replace command. With normal edits, it's difficult to edit many disparate locations at once because of their even slightly different surroundings. An edit to one instance may need to be modified to correctly apply to another instance. This is a reason why conventional word processors provide a separate button for “replace” and “replace all” in its find and replace feature. With smooth edition, this problem disappears. Now, an edit to a single instance can automatically be applied to all instances, and then smoothed ensuring that the edit correctly applies in all instances. When combined with the Concept Picker described herein, smooth editing allows novel ways of editing significantly more powerful than before by abstracting the notion of find and replace. Now, instead of find and replace selecting all instances of a set of words, it can select all instances of a given concept (or more, described in the reference directly above). Then, with smooth editing, these concepts (possibly expressed in dramatically different ways) can all be edited simultaneously. Without smooth editing, this would not be possible.

As shown in FIG. 46, an edit is being made to all the highlighted regions. In this example, the edit is modifying the highlighted regions in some way that makes the displayed textual attribute of the text more extreme (as is represented by the darker gray value). A selected region that is being affected by the edit is shown in the middle of the left document. This edit is not smooth (showing a sudden jump to dark gray from light gray) and possibly creates grammar/flow breaks, as is shown by the broken chain. Note that other instances of this edit is littered throughout the example text.

The edit on the right document is the smooth equivalent to the edit on the left. With the smooth multi-edit, the intended edit is still made while not creating breaks in grammar, flow, textual attribute smoothness, or more.

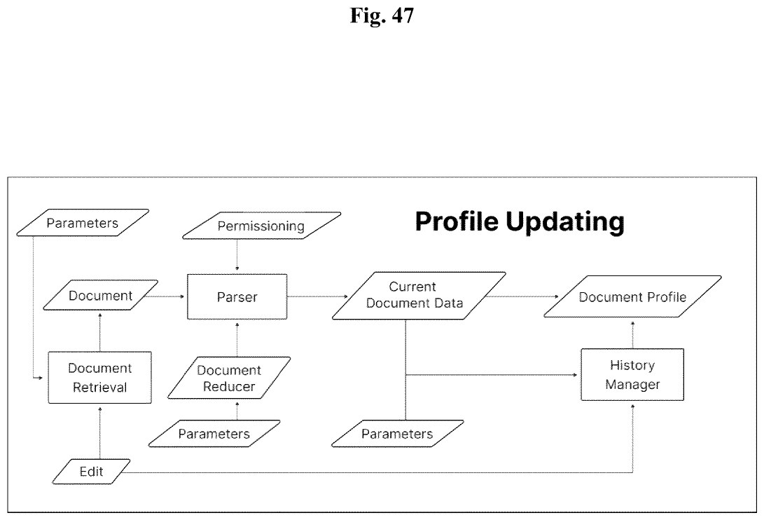

In some embodiments, FIG. 47 describes how a document profile would be updated (or created) based on a user edit. Once a user edits a document, the document profile is now out of date. The document profile can now be updated, or kept constant in an effort to save computation time. In FIG. 47, an update is shown. Note that the document profile includes both the current document state data (such as metrics including how understandable, corporate, or friendly the document is) as well as the output of a history manager, which manages information related to the history of the document's evolution.

Turning to FIG. 47, a user edit is received. This renders the document profile out of date, which allows the possibility of a useful document profile update. A document retrieval step sources the document to be parsed throughout the rest of the process. This document retrieval process may optionally not retrieve the entire document, as the edit may be localized to a small section of the document. Doing so would allow for a more efficient update step.

The document is then outputted by the document retrieval process. A set of parameters can be passed to the document retrieval process. These parameters can impact how much of the document is retrieved, how the document retrieval process works, the fidelity of the retrieved document (a constant tradeoff with speed), or more.

A document parser parses the inputted document into the data stored in the document profile, which can include any set of the textual attributes. Permissioning data can also be passed into the parser, allowing different users or programs to have different permissions to different sections of the document profile. A document reducer specifies how to reduce the text of the document into the metrics and data in the document profile. It allows the process from—as an example—a document to a formality score corresponding to that document and stored in its profile. Some examples of different reducers include average, peak, average weighted by most important sections, or more. A set of parameters that can be passed into the reducer includes a granularity value.

The current document data outputted by the parser and to be inputted into the document profile is also shown. Note that this current document data is also inputted to the history manager. A set of parameters can be passed into the history manager, specifying how the management system works.

A history management system manages the document evolution, editing, and modification history for the profile. This can include how to manage an edit history, storage of previous document data outputted from the parser, create predictions or metrics based on the evolution of the document, or more. The resultant document profile is then updated.

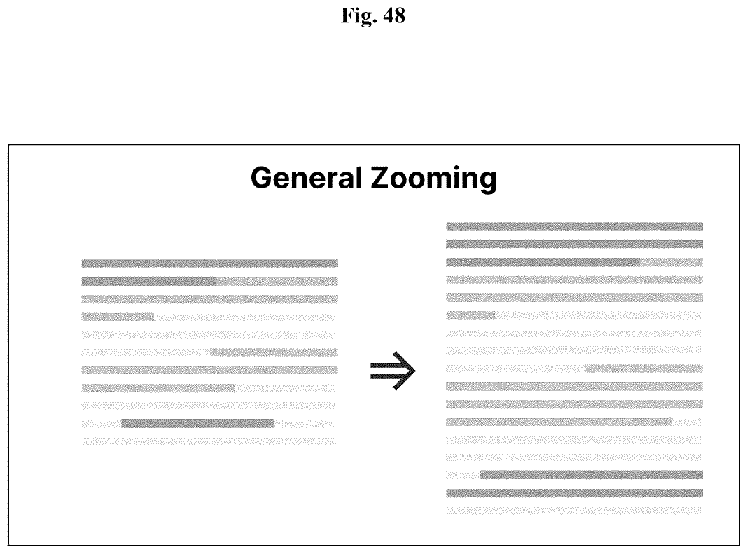

FIG. 48 shows an example of “general zooming”, an effect applied over the whole of the base text. This tool could be applied while creating and editing a text, as well as simply viewing. A sample use-case includes allowing the user to “zoom in” on areas of a text where they require more specificity, much as one would zoom in on relevant locations in maps. Much like most mapping software, zooming would generatively add and delete detail based on zooming inputs, all while maintaining grammatical consistency as well as any defining characteristics of the text, such as formality, tone, etc. The text on the left represents the base text, before the zooming operation, and the text on the right is the zoomed text—in this example, it is zoomed in, creating smaller granularity.

In this example, the zoom is applied evenly over all of the given text, though it could also be centered at a specified location in the text. The shaded blocks represent different severities of a textual attribute, such as formality. These attributes are maintained through the zooming process. While this diagram only displays differing severities of one textual attribute, zooming could maintain multiple attributes with different and possibly overlapping severity maps in the same manner. This diagram also uses discrete blocks to represent different severity levels, while in use, they can be continuous.

The darker segment of text represents a portion of the text with a specific intensity of textual attribute that differs from that around it.

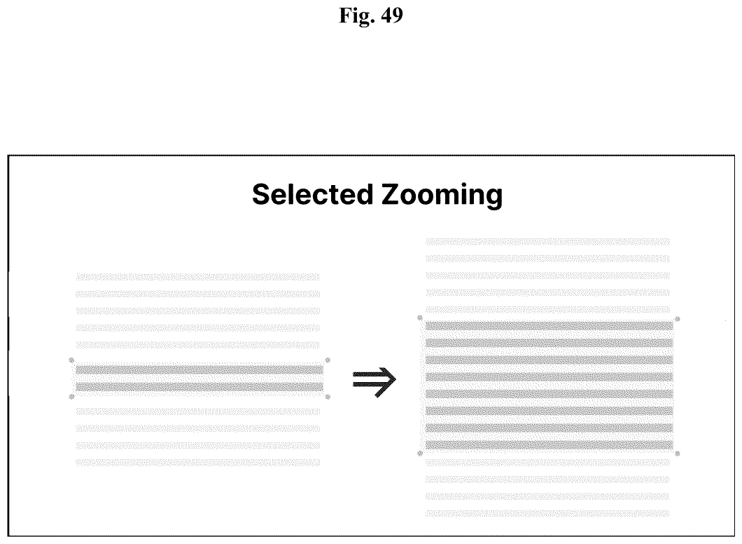

FIG. 49 shows an example of zooming on a selected portion of text. Just as in FIG. 48, any textual attributes are maintained through the zooming process. The new portion of text can be grammatically and thematically integrated into the surrounding text. The text highlighted is user selected text that is transformed—in this example, “zoomed in”. The text block on the left represents the base text, and the text block on the right represents the text with the new and integrated zoomed selection.

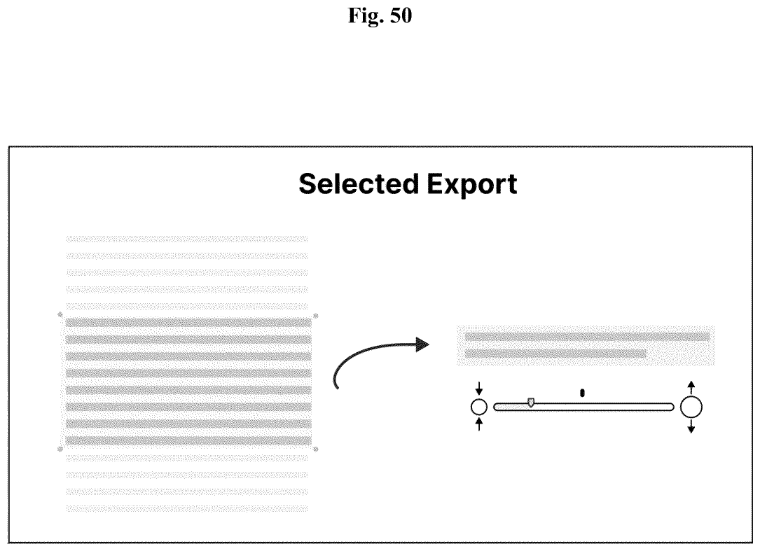

FIG. 50 provides an example of the zoom operation being applied to a separate copy of the base text, while leaving the base text unchanged. This function has many use cases, including exporting summaries and generating outlines with arbitrary granularity. In this figure, the function is operating on a selected portion of the text. However, it could also be applied to the text as a whole, as it would necessarily be when generating whole outlines. The text on the left is the base text, and the highlighted section is user selection. The example zooming interface in this figure is a slider, with the origin demarcated in the center. The text on the right is the zoomed text, which notably is a separate entity from the base text.

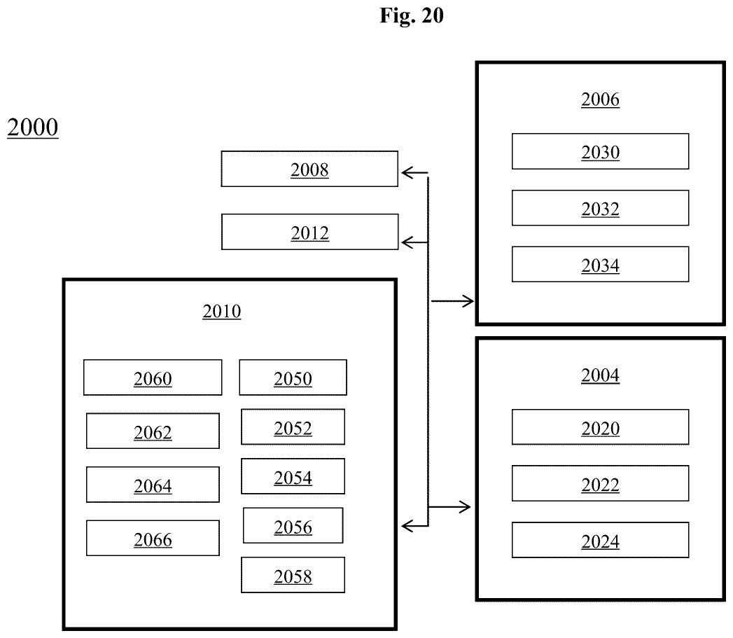

FIG. 20 is a block diagram illustrating a software architecture 2000, which can be installed on any one or more of the devices described above. FIG. 20 is merely a non-limiting example of a software architecture, and it will be appreciated that many other architectures can be implemented to facilitate the functionality described herein. In various embodiments, the software architecture 2000 is implemented by hardware such as a machine 2100 of FIG. 21.

In this example architecture, the software architecture 2000 can be conceptualized as a stack of layers where each layer may provide a particular functionality. For example, the software architecture 2000 includes layers such as an operating system 2004, libraries 2006, frameworks 2008, and applications 2010. Operationally, the applications 2010 invoke API calls 2012 through the software stack and receive messages 2014 in response to the API calls 2012, consistent with some embodiments.

In various implementations, the operating system 2004 manages hardware resources and provides common services. The operating system 2004 includes, for example, a kernel 2020, services 2022, and drivers 2024. The kernel 2020 acts as an abstraction layer between the hardware and the other software layers, consistent with some embodiments. For example, the kernel 2020 provides memory management, processor management (e.g., scheduling), component management, networking, and security settings, among other functionality. The services 2022 can provide other common services for the other software layers. The drivers 2024 are responsible for controlling or interfacing with the underlying hardware, according to some embodiments. For instance, the drivers 2024 can include display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 2006 provide a low-level common infrastructure utilized by the applications 2010. The libraries 2006 can include system libraries 2030 (e.g., C standard library) that can provide functions such as memory allocation functions, string manipulation functions, mathematic functions, and the like. In addition, the libraries 2006 can include API libraries 2032 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in 2D and 3D in a graphic context on a display), database libraries (e.g., SQLite to provide various relational database functions), web libraries (e.g., WebKit to provide web browsing functionality), and the like. The libraries 2006 can also include a wide variety of other libraries 2034 to provide many other APIs to the applications 2010.

The frameworks 2008 provide a high-level common infrastructure that can be utilized by the applications 2010, according to some embodiments. For example, the frameworks 2008 provide various graphical user interface (GUI) functions, high-level resource management, high-level location services, and so forth. The frameworks 2008 can provide a broad spectrum of other APIs that can be utilized by the applications 2010, some of which may be specific to a particular operating system 2004 or platform.

In an example embodiment, the applications 2010 include a home application 2050, a contacts application 2052, a browser application 2054, a book reader application 2056, a location application 2058, a media application 2060, a messaging application 2062, a game application 2064, and a broad assortment of other applications, such as a third-party application 2066. According to some embodiments, the applications 2010 are programs that execute functions defined in the programs. Various programming languages can be employed to create one or more of the applications 2010, structured in a variety of manners, such as object-oriented programming languages (e.g., Objective-C, Java, or C++) or procedural programming languages (e.g., C or assembly language). In a specific example, the third-party application 2066 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 2066 can invoke the API calls 2012 provided by the operating system 2004 to facilitate functionality described herein.

FIG. 21 illustrates a diagrammatic representation of a machine 2100 in the form of a computer system within which a set of instructions may be executed for causing the machine 2100 to perform any one or more of the methodologies discussed herein, according to an example embodiment. Specifically, FIG. 21 shows a diagrammatic representation of the machine 2100 in the example form of a computer system, within which instructions 2116 (e.g., software, a program, an application, an applet, an app, or other executable code) for causing the machine 2100 to perform any one or more of the methodologies discussed herein may be executed. For example, the instructions 2116 may cause the machine 2100 to execute the methods described herein. The instructions 2116 transform the general, non-programmed machine 2100 into a particular machine 2100 programmed to carry out the described and illustrated functions in the manner described. In alternative embodiments, the machine 2100 operates as a standalone device or may be coupled (e.g., networked) to other machines. In a networked deployment, the machine 2100 may operate in the capacity of a server machine or a client machine in a server-client network environment, or as a peer machine in a peer-to-peer (or distributed) network environment. The machine 2100 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 2116, sequentially or otherwise, that specify actions to be taken by the machine 2100. Further, while only a single machine 2100 is illustrated, the term “machine” shall also be taken to include a collection of machines 2100 that individually or jointly execute the instructions 2116 to perform any one or more of the methodologies discussed herein.

The machine 2100 may include processors 2110, memory 2130, and I/O components 2150, which may be configured to communicate with each other such as via a bus 2102. In an example embodiment, the processors 2110 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 2112 and a processor 2114 that may execute the instructions 2116. The term “processor” is intended to include multi-core processors that may comprise two or more independent processors (sometimes referred to as “cores”) that may execute instructions 2116 contemporaneously. Although FIG. 21 shows multiple processors 2110, the machine 2100 may include a single processor 2112 with a single core, a single processor 2112 with multiple cores (e.g., a multi-core processor 2112), multiple processors 2112, 2114 with a single core, multiple processors 2112, 2114 with multiple cores, or any combination thereof.

The memory 2130 may include a main memory 2132, a static memory 2134, and a storage unit 2136, each accessible to the processors 2110 such as via the bus 2102. The main memory 2132, the static memory 2134, and the storage unit 2136 store the instructions 2116 embodying any one or more of the methodologies or functions described herein. The instructions 2116 may also reside, completely or partially, within the main memory 2132, within the static memory 2134, within the storage unit 2136, within at least one of the processors 2110 (e.g., within the processor's cache memory), or any suitable combination thereof, during execution thereof by the machine 2100.

The I/O components 2150 may include a wide variety of components to receive input, provide output, produce output, transmit information, exchange information, capture measurements, and so on. The specific I/O components 2150 that are included in a particular machine will depend on the type of machine. For example, portable machines such as mobile phones will likely include a touch input device or other such input mechanisms, while a headless server machine will likely not include such a touch input device. It will be appreciated that the I/O components 2150 may include many other components that are not shown in FIG. 21. The I/O components 2150 are grouped according to functionality merely for simplifying the following discussion, and the grouping is in no way limiting. In various example embodiments, the I/O components 650 may include output components 2152 and input components 2154. The output components 2152 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 2154 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 2150 may include biometric components 2156, motion components 2158, environmental components 2160, or position components 2162, among a wide array of other components. For example, the biometric components 2156 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 2158 may include acceleration sensor components (e.g., accelerometer), gravitation sensor components, rotation sensor components (e.g., gyroscope), and so forth. The environmental components 2160 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 2162 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 2150 may include communication components 2164 operable to couple the machine 2100 to a network 2180 or devices 2170 via a coupling 2182 and a coupling 2172, respectively. For example, the communication components 2164 may include a network interface component or another suitable device to interface with the network 2180. In further examples, the communication components 2164 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 2170 may be another machine or any of a wide variety of peripheral devices (e.g., coupled via a USB).

Moreover, the communication components 2164 may detect identifiers or include components operable to detect identifiers. For example, the communication components 2164 may include radio-frequency identification (RFID) tag reader components, NFC smart tag detection components, optical reader components (e.g., an optical sensor to detect one-dimensional bar codes such as Universal Product Code (UPC) bar code, multi-dimensional bar codes such as QR code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 2164, such as location via Internet Protocol (IP) geolocation, location via Wi-Fi® signal triangulation, location via detecting an NFC beacon signal that may indicate a particular location, and so forth.

The various memories (i.e., 2130, 2132, 2134, and/or memory of the processor(s) 2110) and/or the storage unit 2136 may store one or more sets of instructions 2116 and data structures (e.g., software) embodying or utilized by any one or more of the methodologies or functions described herein. These instructions (e.g., the instructions 2116), when executed by the processor(s) 2110, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 2180 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 2180 or a portion of the network 2180 may include a wireless or cellular network, and the coupling 2182 may be a Code Division Multiple Access (CDMA) connection, a Global System for Mobile communications (GSM) connection, or another type of cellular or wireless coupling. In this example, the coupling 2182 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 2116 may be transmitted or received over the network 2180 using a transmission medium via a network interface device (e.g., a network interface component included in the communication components 2164) and utilizing any one of a number of well-known transfer protocols (e.g., Hypertext Transfer Protocol (HTTP)). Similarly, the instructions 2116 may be transmitted or received using a transmission medium via the coupling 2172 (e.g., a peer-to-peer coupling) to the devices 2170. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 2116 for execution by the machine 2100, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

Embodiments of this solution may be implemented in one or a combination of hardware, firmware and software. Embodiments may also be implemented as instructions stored on a computer-readable storage device, which may be read and executed by at least one processor to perform the operations described herein. A computer-readable storage device may include any non-storing information in a form readable by a machine (e.g., a computer). For example, a computer-readable storage device may include read-only memory (ROM), random-access memory (RAM), magnetic disk storage media, optical storage media, flash-memory devices, cloud servers or other storage devices and media. Some embodiments may include one or more processors and may be configured with instructions stored on a computer-readable storage device. The following description and the referenced drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

The above description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72 (b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The disclosed embodiments are susceptible to various modifications and alternative forms, and specific examples thereof have been shown by way of example in the drawings and are herein described in detail. It should be understood, however, that the disclosed embodiments are not to be limited to the particular forms or methods disclosed, but to the contrary, the disclosed embodiments are to cover all modifications, equivalents, and alternatives.

What is claimed is:

1. A system for applying one or more effects to source text, comprising:
an input for receiving the source text; and
a graph of one or more connected nodes, each node being connected to at least one other node by an edge and representing the one or more effects on the source text, wherein each node of the graph receives at least one of the source text or an output from another node of the graph.

2. The system of claim 1, wherein the graph is a non-linear effect stack and at least one of the connected nodes is a cross-dimensional node that can receive more than one input or produce more than one output.

3. The system of claim 2, wherein the at least one of the connected nodes is a splitter that receives a single input and splits the single input into more than one output edge.

4. The system of claim 3, wherein the more than one output edge includes a content stream of the source text and a style stream of the source text.

5. The system of claim 2, wherein the at least one of the connected nodes is a combiner that receives at least two inputs and combines the at least two inputs into a single output edge based on a combination type of the combiner.

6. The system of claim 5, wherein said combination type includes at least one of a semantically additive type, semantically subtractive type, a best along a predetermined criteria, and a blending mode.

7. The system of claim 1, wherein each connected node is defined by a stream type that defines the input that a particular node expects to receive.

8. The system of claim 1, wherein each edge between connected nodes is defined by a stream weight, the stream weight providing a global multiplier on text transparency.

9. The system of claim 1, wherein said one or more effects comprises at least one of a filter, a generator, and a viewer.

10. The system of claim 1, further comprising a graphical user interface for editing the one or more effects.

11. A method for applying one or more effects to source text, comprising:
receiving the source text at an input; and
applying the one or more effects to the received source text, wherein the one or more effects are represented by a graph of one or more connected nodes, each node being connected to at least one other node by an edge and representing the one or more effects on the text, wherein each node of the graph receives at least one of the source text or an output from another node of the graph.

12. The method of claim 11, wherein the graph is a non-linear effect stack and at least one of the connected nodes is a cross-dimensional node that can receive more than one input or produce more than one output.

13. The method of claim 12, wherein the at least one of the connected nodes is a splitter, said method further comprises receiving a single input at the splitter and splitting the received single input into more than one output edge.

14. The method of claim 13, wherein said splitting the received single input into more than one output edge includes splitting the single input into a content stream of the source text and a style stream of the source text.

15. The method of claim 12, wherein the at least one of the connected nodes is a combiner that receives at least two inputs, said method further comprising combining the at least two inputs into a single output edge at the combiner based on a combination type of the combiner.

16. The method of claim 15, wherein said combination type includes at least one of a semantically additive type, semantically subtractive type, a best along a predetermined criteria, and a blending mode.

17. The method of claim 11, wherein each connected node is defined by a stream type that defines the input that a particular node expects to receive.

18. The method of claim 11, wherein each edge between connected nodes is defined by a stream weight, the stream weight providing a global multiplier on text transparency.

19. The method of claim 11, wherein said one or more effects comprises at least one of a filter, a generator, and a viewer.

20. The method of claim 1, further comprising providing a graphical user interface for editing the one or more effects.
